(19) United States
(12) Patent Application Publication
(10) Pub. No.: US 2026/0358939 A1
(43) Pub. Date: Nov. 12, 2026

(54) USER INTERFACES AND TECHNIQUES FOR MANAGING SETTINGS

(71) Applicant: Apple, Inc., Cupertino, CA (US)

(72) Inventor: Daniel M. GOLDEN, San Jose, CA (US)

(21) Appl. No.: 19/673,548

(22) Filed: May 11, 2026

Related U.S. Application Data
(60) Provisional application No. 63/804,541, filed on May 12, 2025.

(51) Int. Cl. G06F 3/0484

(52) U.S. Cl. CPC G06F 3/0484

(57) ABSTRACT

The present disclosure generally relates to managing settings. Some techniques are for sharing settings in accordance with some embodiments. Other techniques are for zooming content in accordance with some embodiments.

### CROSS-REFERENCE TO RELATED APPLICATIONS

This application claims priority to U.S. Provisional Patent Application Ser. No. 63/804,541, entitled “User Interfaces and Techniques for Managing Settings,” filed May 12, 2025. The content of this application is hereby incorporated by reference in their entirety.

### FIELD

The present disclosure relates generally to computer user interfaces, and more specifically to techniques for managing settings.

### BACKGROUND

Electronic devices often include one or more settings to personalize output of content. Such settings can include how text size and/or whether colors of content are inverted.

### SUMMARY

Some techniques for managing settings using electronic devices are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for managing settings. Such processes and interfaces optionally complement or replace other processes for managing settings. Such processes and interfaces reduce the cognitive burden on a user and produce a more efficient human-machine interface. For battery-operated computing devices, such processes and interfaces conserve power and increase the time between battery charges.

In some embodiments, a method that is performed at a first computer system that is in communication with one or more display generation components and one or more input devices is described. In some embodiments, the method comprises: displaying, via the one or more display generation components, a user interface according to a first set of one or more settings; while displaying the user interface according to the first set of one or more settings, receiving, from a second computer system different from the first computer system, a respective set of one or more settings; in response to receiving the respective set of one or more settings, displaying, via the one or more display generation components, a user interface element to apply the respective set of one or more settings to the first computer system; while displaying the user interface element to apply the respective set of one or more settings to the first computer system, detecting, via the one or more input devices, an input corresponding to the user interface element to apply the respective set of one or more settings to the first computer system; and in response to detecting the input corresponding to the user interface element to apply the respective set of one or more settings to the first computer system: in accordance with a determination that the respective set of one or more settings includes a first setting, displaying, via the one or more display generation components, the user interface with a first appearance according to the first setting; and in accordance with a determination that the respective set of one or more settings includes a second setting, displaying, via the one or more display generation components, the user interface with a second appearance according to the second setting, wherein the second setting is different from the first setting, and wherein the second appearance is different from the first appearance.

In some embodiments, a non-transitory computer-readable storage medium storing one or more programs configured to be executed by one or more processors of a first computer system that is in communication with one or more display generation components and one or more input devices is described. In some embodiments, the one or more programs includes instructions for: displaying, via the one or more display generation components, a user interface according to a first set of one or more settings; while displaying the user interface according to the first set of one or more settings, receiving, from a second computer system different from the first computer system, a respective set of one or more settings; in response to receiving the respective set of one or more settings, displaying, via the one or more display generation components, a user interface element to apply the respective set of one or more settings to the first computer system; while displaying the user interface element to apply the respective set of one or more settings to the first computer system, detecting, via the one or more input devices, an input corresponding to the user interface element to apply the respective set of one or more settings to the first computer system; and in response to detecting the input corresponding to the user interface element to apply the respective set of one or more settings to the first computer system: in accordance with a determination that the respective set of one or more settings includes a first setting, displaying, via the one or more display generation components, the user interface with a first appearance according to the first setting; and in accordance with a determination that the respective set of one or more settings includes a second setting, displaying, via the one or more display generation components, the user interface with a second appearance according to the second setting, wherein the second setting is different from the first setting, and wherein the second appearance is different from the first appearance.

In some embodiments, a transitory computer-readable storage medium storing one or more programs configured to be executed by one or more processors of a first computer system that is in communication with one or more display generation components and one or more input devices is described. In some embodiments, the one or more programs includes instructions for: displaying, via the one or more display generation components, a user interface according to a first set of one or more settings; while displaying the user interface according to the first set of one or more settings, receiving, from a second computer system different from the first computer system, a respective set of one or more settings; in response to receiving the respective set of one or more settings, displaying, via the one or more display generation components, a user interface element to apply the respective set of one or more settings to the first computer system; while displaying the user interface element to apply the respective set of one or more settings to the first computer system, detecting, via the one or more input devices, an input corresponding to the user interface element to apply the respective set of one or more settings to the first computer system; and in response to detecting the input corresponding to the user interface element to apply the respective set of one or more settings to the first computer system: in accordance with a determination that the respective set of one or more settings includes a first setting, displaying, via the one or more display generation components, the user interface with a first appearance according to the first setting; and in accordance with a determination that the respective set of one or more settings includes a second setting, displaying, via the one or more display generation components, the user interface with a second appearance according to the second setting, wherein the second setting is different from the first setting, and wherein the second appearance is different from the first appearance.

In some embodiments, a first computer system configured to communicate with one or more display generation components and one or more input devices is described. In some embodiments, the first computer system comprises one or more processors and memory storing one or more programs configured to be executed by the one or more processors. In some embodiments, the one or more programs includes instructions for: displaying, via the one or more display generation components, a user interface according to a first set of one or more settings; while displaying the user interface according to the first set of one or more settings, receiving, from a second computer system different from the first computer system, a respective set of one or more settings; in response to receiving the respective set of one or more settings, displaying, via the one or more display generation components, a user interface element to apply the respective set of one or more settings to the first computer system; while displaying the user interface element to apply the respective set of one or more settings to the first computer system, detecting, via the one or more input devices, an input corresponding to the user interface element to apply the respective set of one or more settings to the first computer system; and in response to detecting the input corresponding to the user interface element to apply the respective set of one or more settings to the first computer system: in accordance with a determination that the respective set of one or more settings includes a first setting, displaying, via the one or more display generation components, the user interface with a first appearance according to the first setting; and in accordance with a determination that the respective set of one or more settings includes a second setting, displaying, via the one or more display generation components, the user interface with a second appearance according to the second setting, wherein the second setting is different from the first setting, and wherein the second appearance is different from the first appearance.

In some embodiments, a first computer system configured to communicate with one or more display generation components and one or more input devices is described. In some embodiments, the first computer system comprises means for performing each of the following steps: displaying, via the one or more display generation components, a user interface according to a first set of one or more settings; while displaying the user interface according to the first set of one or more settings, receiving, from a second computer system different from the first computer system, a respective set of one or more settings; in response to receiving the respective set of one or more settings, displaying, via the one or more display generation components, a user interface element to apply the respective set of one or more settings to the first computer system; while displaying the user interface element to apply the respective set of one or more settings to the first computer system, detecting, via the one or more input devices, an input corresponding to the user interface element to apply the respective set of one or more settings to the first computer system; and in response to detecting the input corresponding to the user interface element to apply the respective set of one or more settings to the first computer system: in accordance with a determination that the respective set of one or more settings includes a first setting, displaying, via the one or more display generation components, the user interface with a first appearance according to the first setting; and in accordance with a determination that the respective set of one or more settings includes a second setting, displaying, via the one or more display generation components, the user interface with a second appearance according to the second setting, wherein the second setting is different from the first setting, and wherein the second appearance is different from the first appearance.

In some embodiments, a computer program product is described. In some embodiments, the computer program product comprises one or more programs configured to be executed by one or more processors of a first computer system that is in communication with one or more display generation components and one or more input devices. In some embodiments, the one or more programs include instructions for: displaying, via the one or more display generation components, a user interface according to a first set of one or more settings; while displaying the user interface according to the first set of one or more settings, receiving, from a second computer system different from the first computer system, a respective set of one or more settings; in response to receiving the respective set of one or more settings, displaying, via the one or more display generation components, a user interface element to apply the respective set of one or more settings to the first computer system; while displaying the user interface element to apply the respective set of one or more settings to the first computer system, detecting, via the one or more input devices, an input corresponding to the user interface element to apply the respective set of one or more settings to the first computer system; and in response to detecting the input corresponding to the user interface element to apply the respective set of one or more settings to the first computer system: in accordance with a determination that the respective set of one or more settings includes a first setting, displaying, via the one or more display generation components, the user interface with a first appearance according to the first setting; and in accordance with a determination that the respective set of one or more settings includes a second setting, displaying, via the one or more display generation components, the user interface with a second appearance according to the second setting, wherein the second setting is different from the first setting, and wherein the second appearance is different from the first appearance.

In some embodiments, a method that is performed at a first computer system that is in communication with one or more display generation components and one or more input devices is described. In some embodiments, the method comprises: displaying, via the one or more display generation components, a virtual environment including a user interface element at a first zoom level and a representation of a camera feed at a second zoom level; while displaying the virtual environment including the user interface element at the first zoom level and the representation of the camera feed at the second zoom level, detecting, via the one or more input devices, an input corresponding to a zoom of a respective portion of the virtual environment; and in response to detecting the input corresponding to the zoom of the respective portion of the virtual environment and in accordance with a determination that the respective portion of the virtual environment corresponds to virtual elements and physical elements, displaying, via the one or more display generation components, the virtual environment including the user interface element at a third zoom level and the representation of the camera feed at a fourth zoom level, wherein the third zoom level is different from the first zoom level, and wherein the fourth zoom level is different from the second zoom level.

In some embodiments, a non-transitory computer-readable storage medium storing one or more programs configured to be executed by one or more processors of a first computer system that is in communication with one or more display generation components and one or more input devices is described. In some embodiments, the one or more programs includes instructions for: displaying, via the one or more display generation components, a virtual environment including a user interface element at a first zoom level and a representation of a camera feed at a second zoom level; while displaying the virtual environment including the user interface element at the first zoom level and the representation of the camera feed at the second zoom level, detecting, via the one or more input devices, an input corresponding to a zoom of a respective portion of the virtual environment; and in response to detecting the input corresponding to the zoom of the respective portion of the virtual environment and in accordance with a determination that the respective portion of the virtual environment corresponds to virtual elements and physical elements, displaying, via the one or more display generation components, the virtual environment including the user interface element at a third zoom level and the representation of the camera feed at a fourth zoom level, wherein the third zoom level is different from the first zoom level, and wherein the fourth zoom level is different from the second zoom level.

In some embodiments, a transitory computer-readable storage medium storing one or more programs configured to be executed by one or more processors of a first computer system that is in communication with one or more display generation components and one or more input devices is described. In some embodiments, the one or more programs includes instructions for: displaying, via the one or more display generation components, a virtual environment including a user interface element at a first zoom level and a representation of a camera feed at a second zoom level; while displaying the virtual environment including the user interface element at the first zoom level and the representation of the camera feed at the second zoom level, detecting, via the one or more input devices, an input corresponding to a zoom of a respective portion of the virtual environment; and in response to detecting the input corresponding to the zoom of the respective portion of the virtual environment and in accordance with a determination that the respective portion of the virtual environment corresponds to virtual elements and physical elements, displaying, via the one or more display generation components, the virtual environment including the user interface element at a third zoom level and the representation of the camera feed at a fourth zoom level, wherein the third zoom level is different from the first zoom level, and wherein the fourth zoom level is different from the second zoom level.

In some embodiments, a first computer system configured to communicate with one or more display generation components and one or more input devices is described. In some embodiments, the first computer system comprises one or more processors and memory storing one or more programs configured to be executed by the one or more processors. In some embodiments, the one or more programs includes instructions for: displaying, via the one or more display generation components, a virtual environment including a user interface element at a first zoom level and a representation of a camera feed at a second zoom level; while displaying the virtual environment including the user interface element at the first zoom level and the representation of the camera feed at the second zoom level, detecting, via the one or more input devices, an input corresponding to a zoom of a respective portion of the virtual environment; and in response to detecting the input corresponding to the zoom of the respective portion of the virtual environment and in accordance with a determination that the respective portion of the virtual environment corresponds to virtual elements and physical elements, displaying, via the one or more display generation components, the virtual environment including the user interface element at a third zoom level and the representation of the camera feed at a fourth zoom level, wherein the third zoom level is different from the first zoom level, and wherein the fourth zoom level is different from the second zoom level.

In some embodiments, a first computer system configured to communicate with one or more display generation components and one or more input devices is described. In some embodiments, the first computer system comprises means for performing each of the following steps: displaying, via the one or more display generation components, a virtual environment including a user interface element at a first zoom level and a representation of a camera feed at a second zoom level; while displaying the virtual environment including the user interface element at the first zoom level and the representation of the camera feed at the second zoom level, detecting, via the one or more input devices, an input corresponding to a zoom of a respective portion of the virtual environment; and in response to detecting the input corresponding to the zoom of the respective portion of the virtual environment and in accordance with a determination that the respective portion of the virtual environment corresponds to virtual elements and physical elements, displaying, via the one or more display generation components, the virtual environment including the user interface element at a third zoom level and the representation of the camera feed at a fourth zoom level, wherein the third zoom level is different from the first zoom level, and wherein the fourth zoom level is different from the second zoom level.

In some embodiments, a computer program product is described. In some embodiments, the computer program product comprises one or more programs configured to be executed by one or more processors of a first computer system that is in communication with one or more display generation components and one or more input devices. In some embodiments, the one or more programs include instructions for: displaying, via the one or more display generation components, a virtual environment including a user interface element at a first zoom level and a representation of a camera feed at a second zoom level; while displaying the virtual environment including the user interface element at the first zoom level and the representation of the camera feed at the second zoom level, detecting, via the one or more input devices, an input corresponding to a zoom of a respective portion of the virtual environment; and in response to detecting the input corresponding to the zoom of the respective portion of the virtual environment and in accordance with a determination that the respective portion of the virtual environment corresponds to virtual elements and physical elements, displaying, via the one or more display generation components, the virtual environment including the user interface element at a third zoom level and the representation of the camera feed at a fourth zoom level, wherein the third zoom level is different from the first zoom level, and wherein the fourth zoom level is different from the second zoom level.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for managing a set of one or more settings, thereby increasing the effectiveness, efficiency, and user satisfaction with such devices. Such processes and interfaces may complement or replace other processes for managing a set of one or more settings.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6M illustrates exemplary user interfaces for sharing settings in accordance with some embodiments.

FIG. 7 is a flow diagram illustrating a process for sharing settings in accordance with some embodiments.

FIGS. 8A-8G illustrates exemplary user interfaces for zooming content in accordance with some embodiments.

FIG. 9 is a flow diagram illustrating a process for zooming content in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for managing a set of one or more settings. For example, settings can be shared between devices so a user is provided their settings on another device. For another example, a setting can be selected to zoom physical and/or virtual objects. Such techniques can reduce the cognitive burden on a user who uses a computer system with personalized settings and/or manages settings, thereby enhancing productivity. Further, such techniques can reduce processor and battery power otherwise wasted on redundant user inputs.

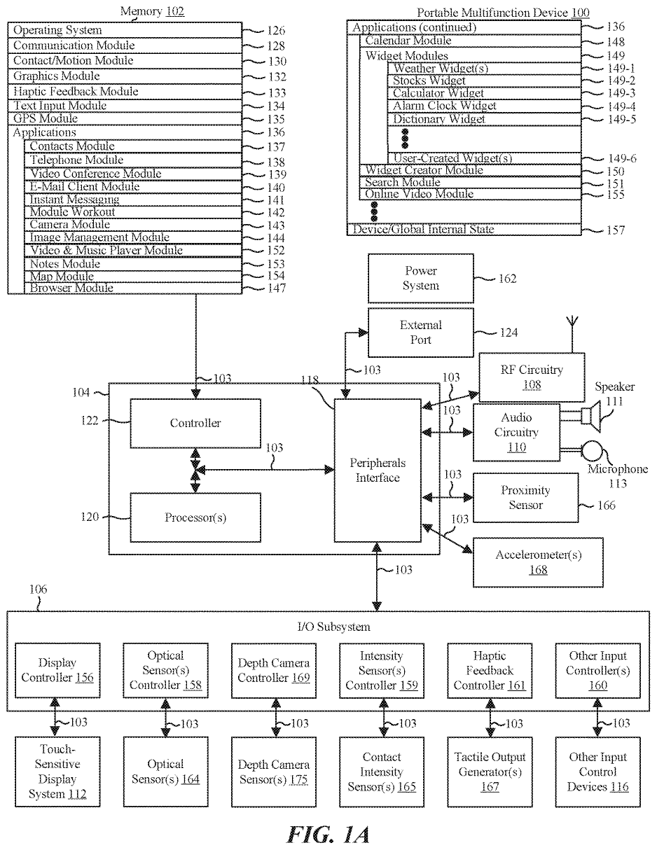

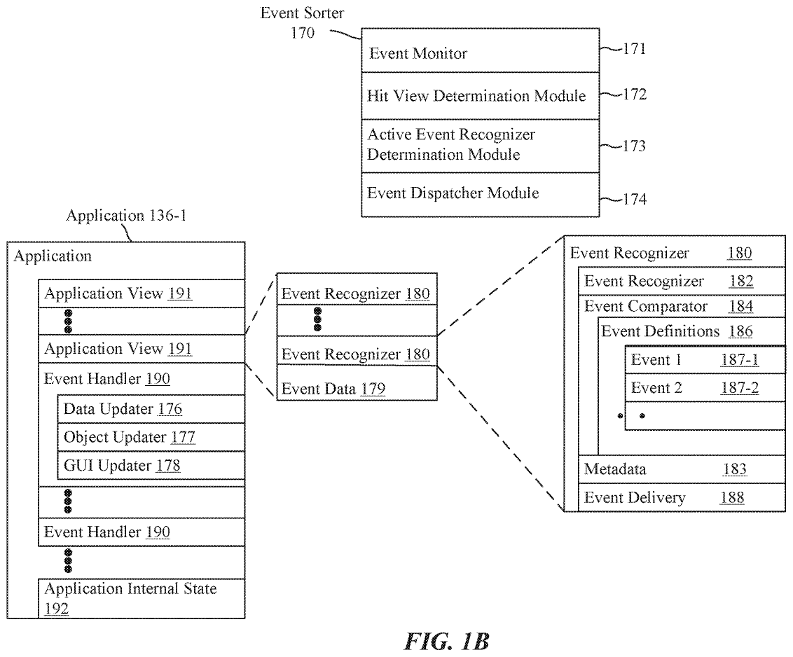

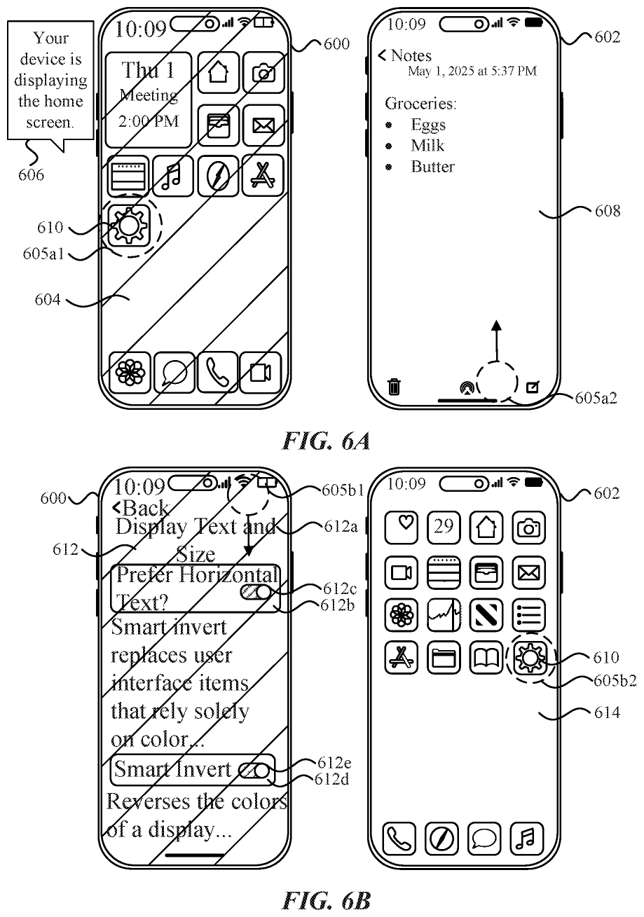

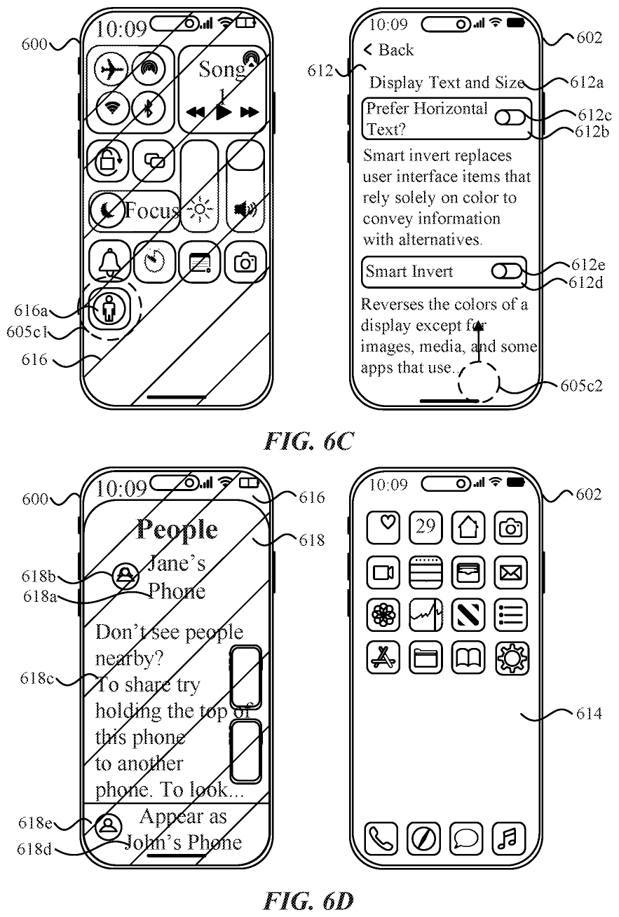

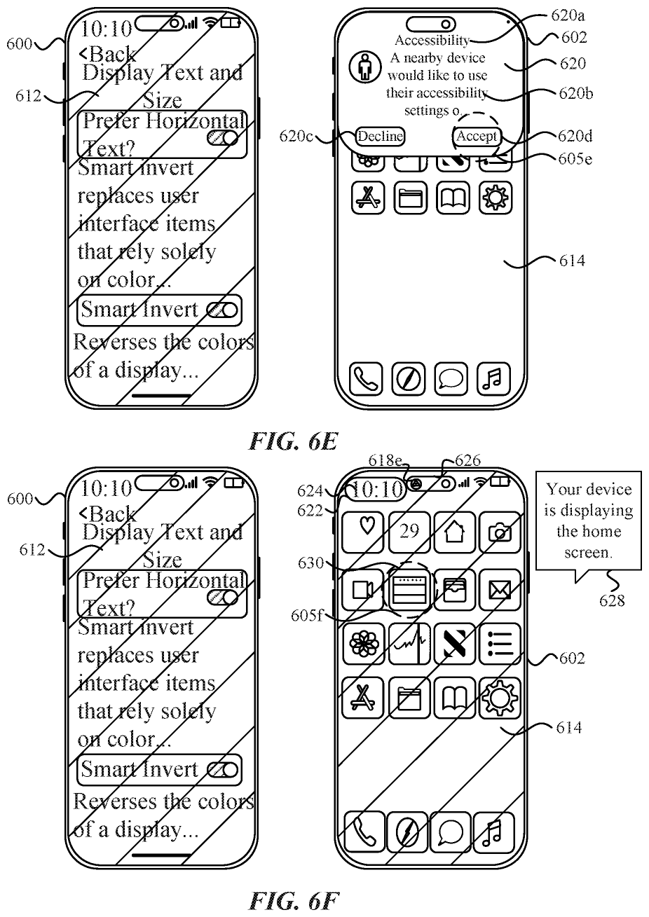

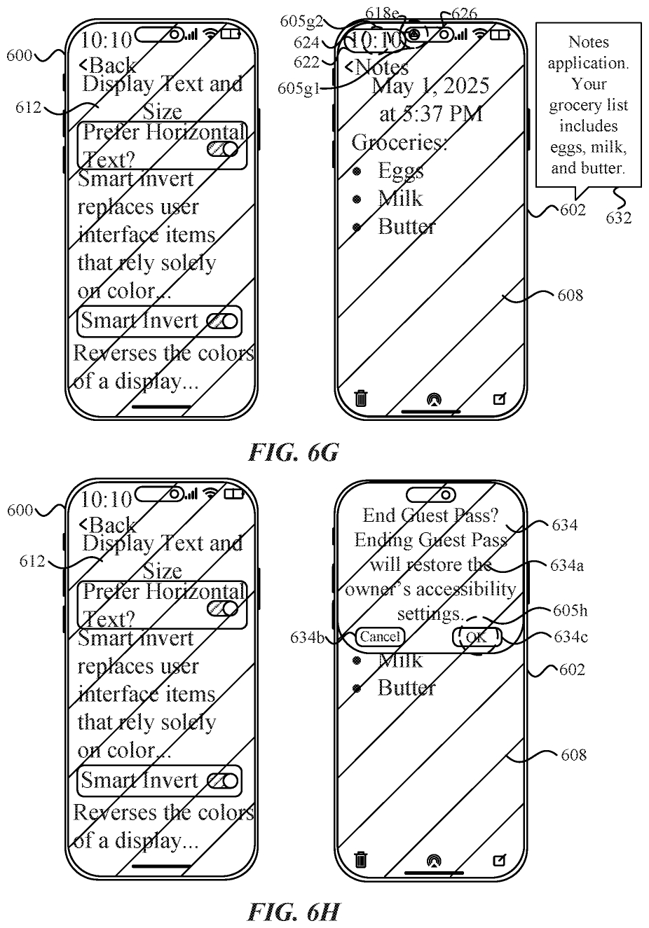

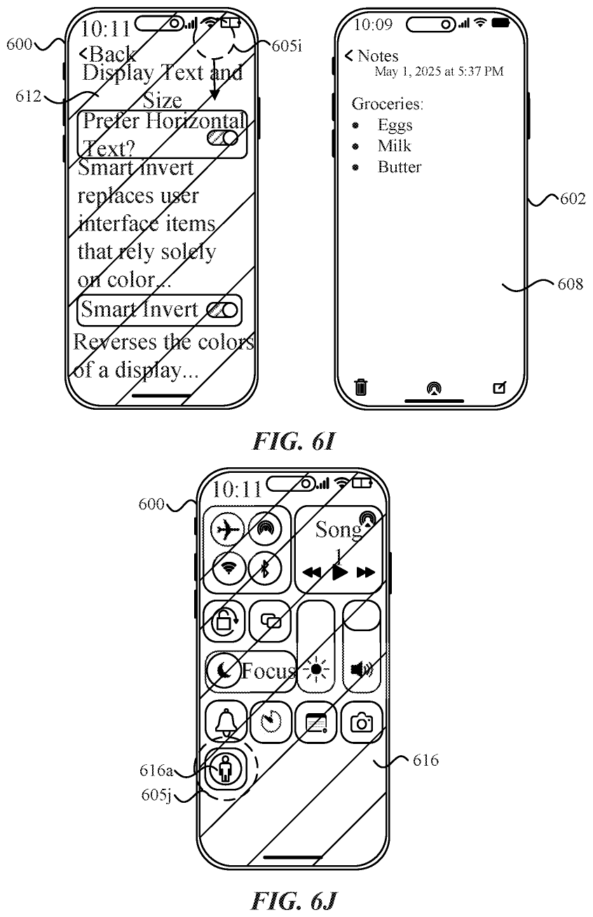

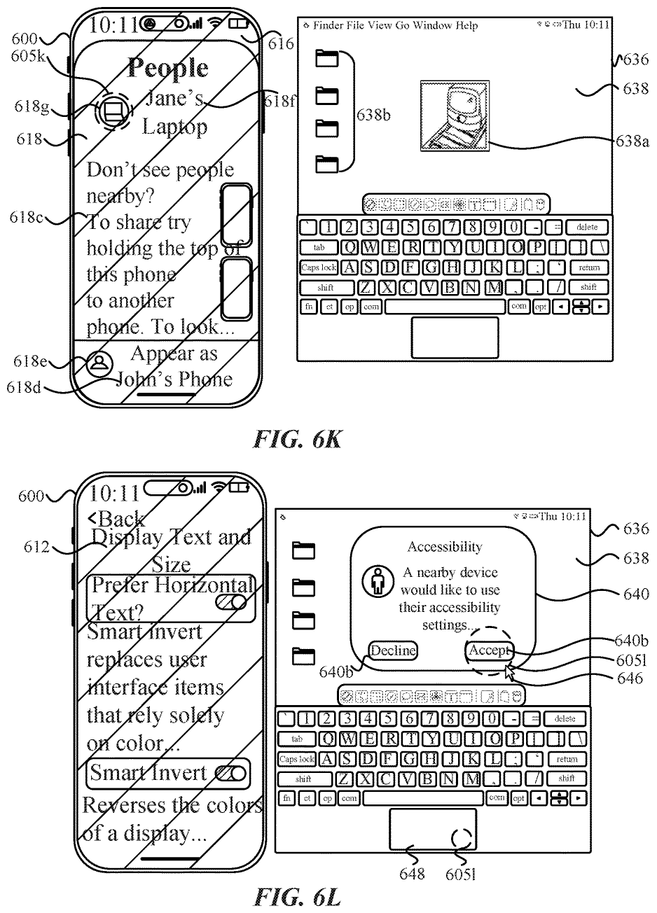

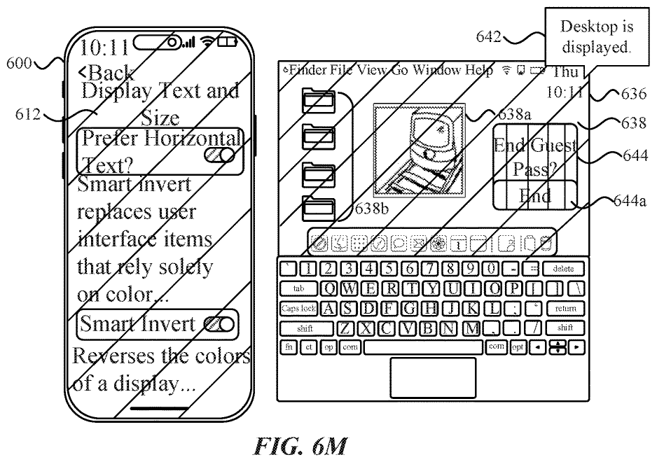

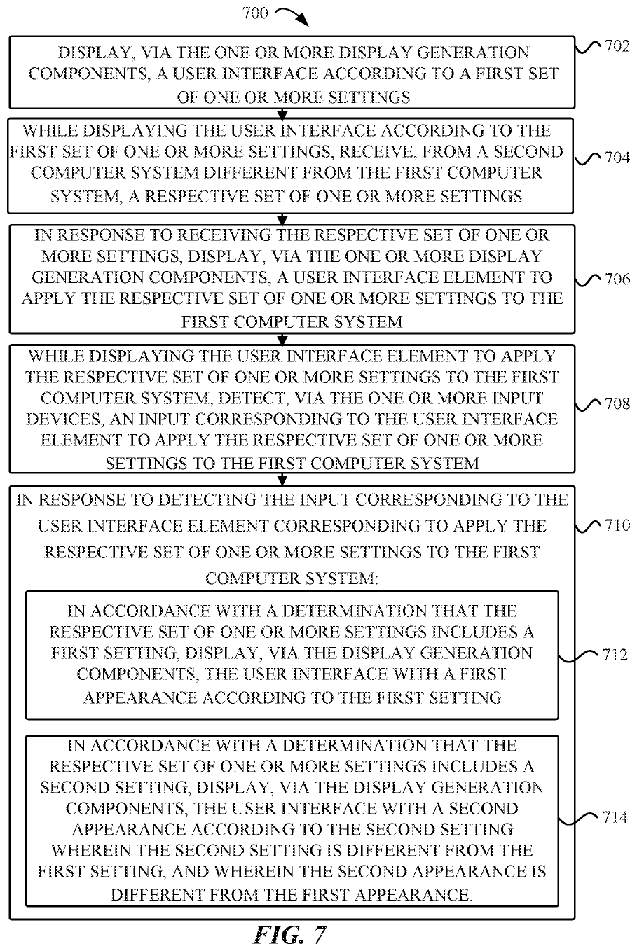

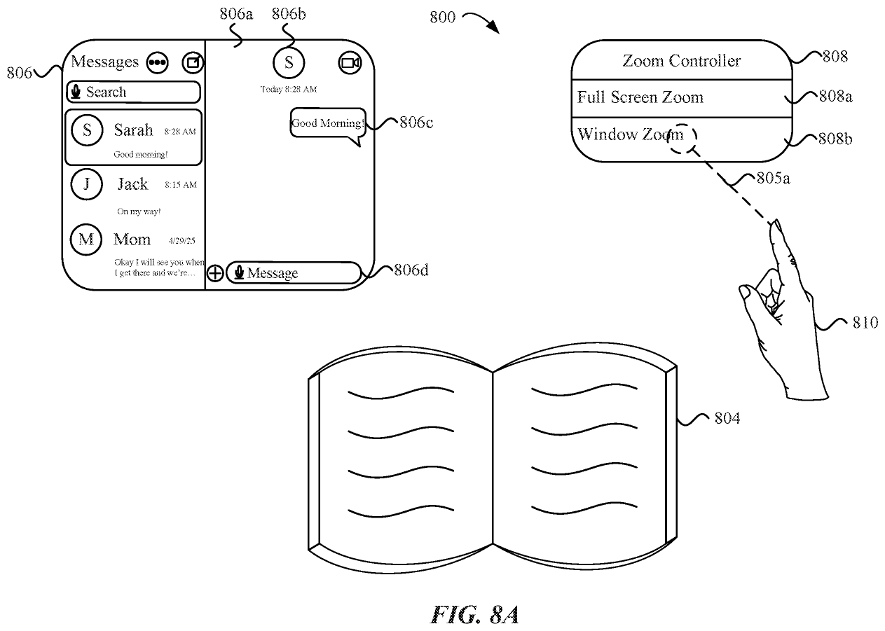

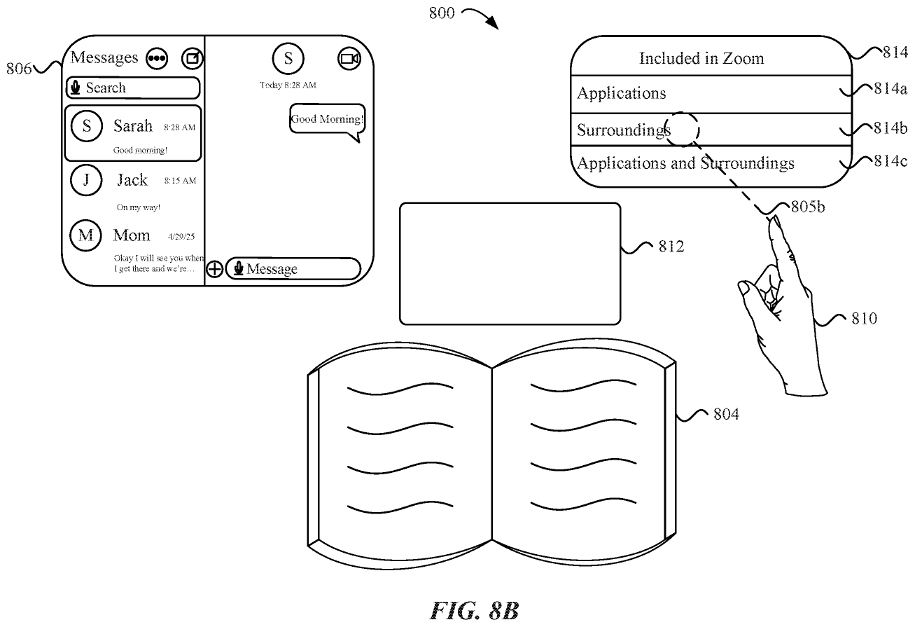

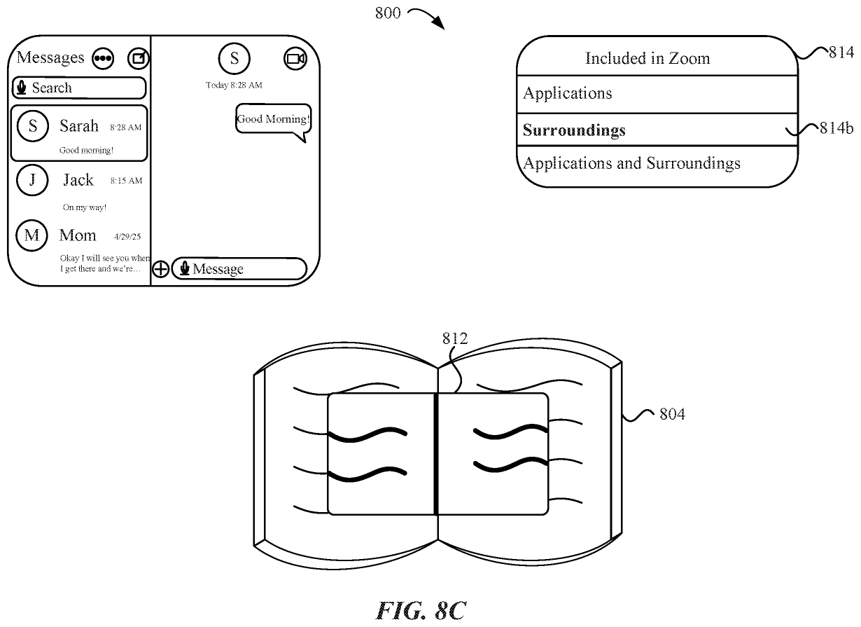

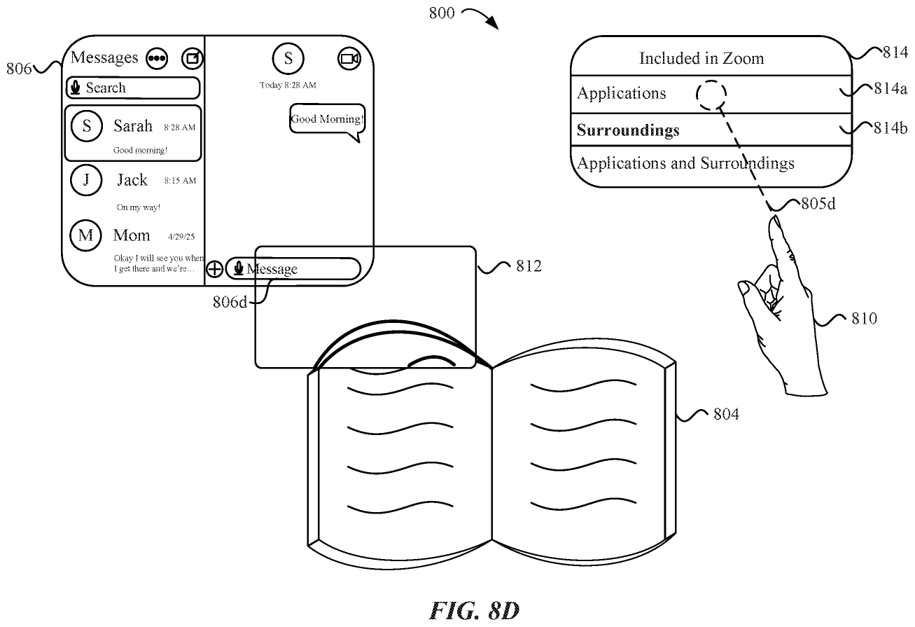

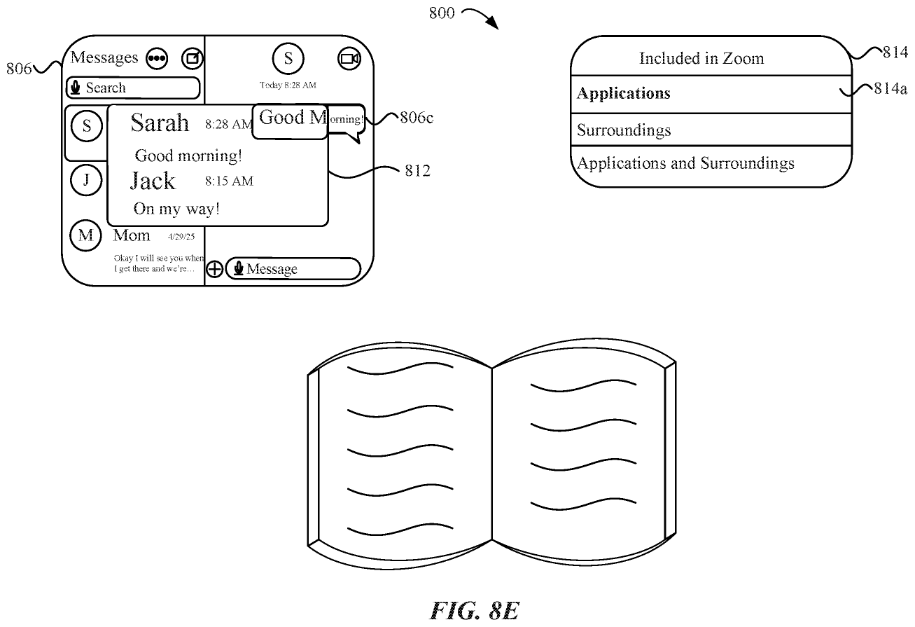

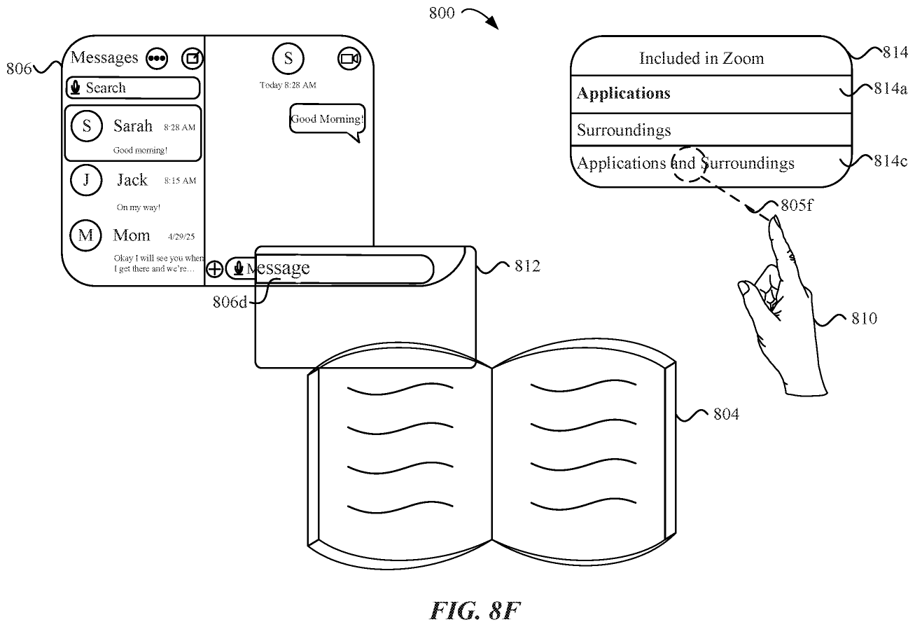

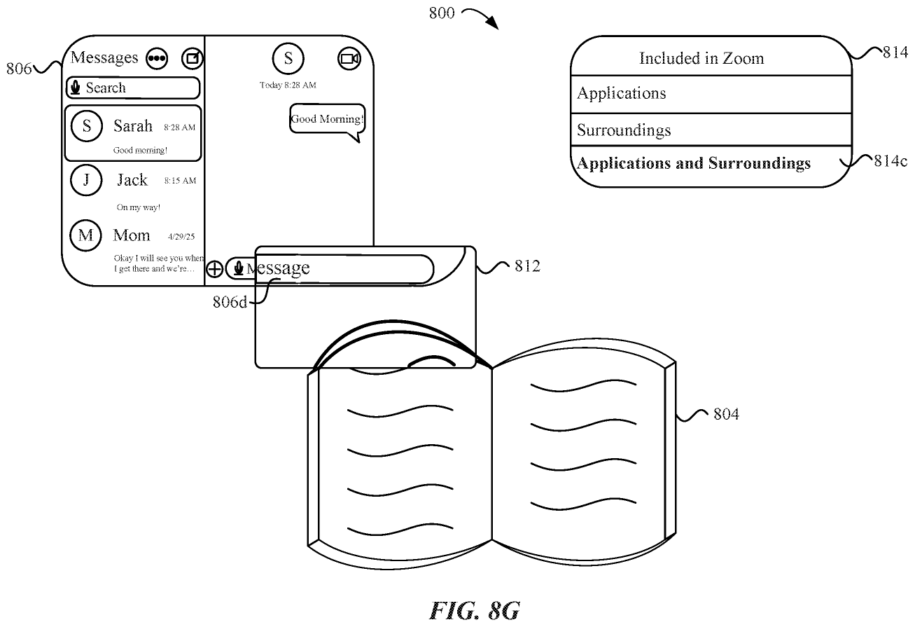

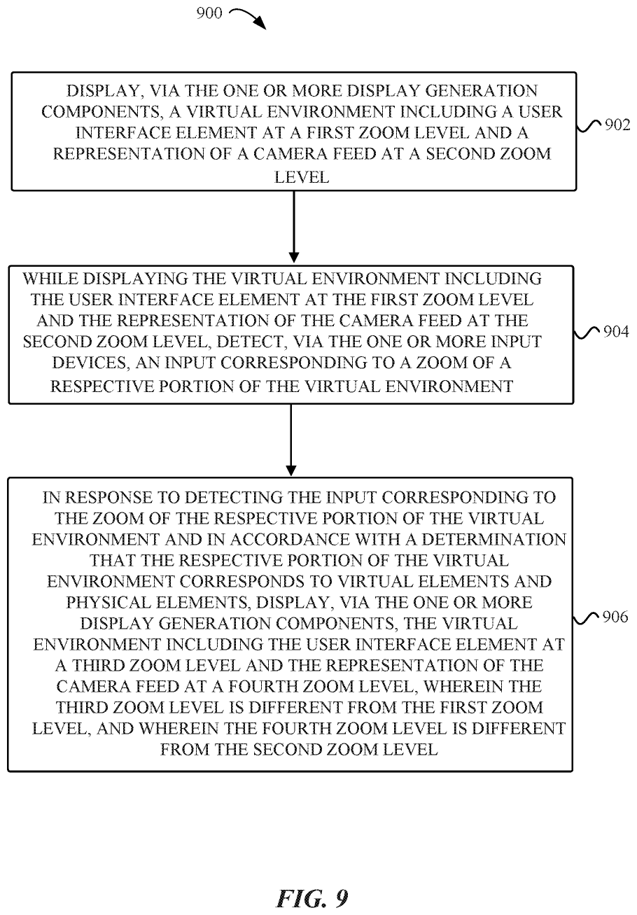

Below, FIGS. 1A-1B, 2, 3A-3G, 4A-4B, and 5A-5B provide a description of exemplary devices for performing the techniques for managing settings. FIGS. 6A-6M illustrates exemplary user interfaces for sharing settings in accordance with some embodiments. FIG. 7 is a flow diagram illustrating a process for sharing settings in accordance with some embodiments. The user interfaces in FIGS. 6A-6M are used to illustrate the processes described below, including the processes in FIG. 7. FIGS. 8A-8G illustrates exemplary user interfaces for zooming content in accordance with some embodiments. FIG. 9 is a flow diagram illustrating a process for zooming content in accordance with some embodiments. The user interfaces in FIGS. 8A-8G are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms unless explicitly stated with an order and/or that they are separate and/or different. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

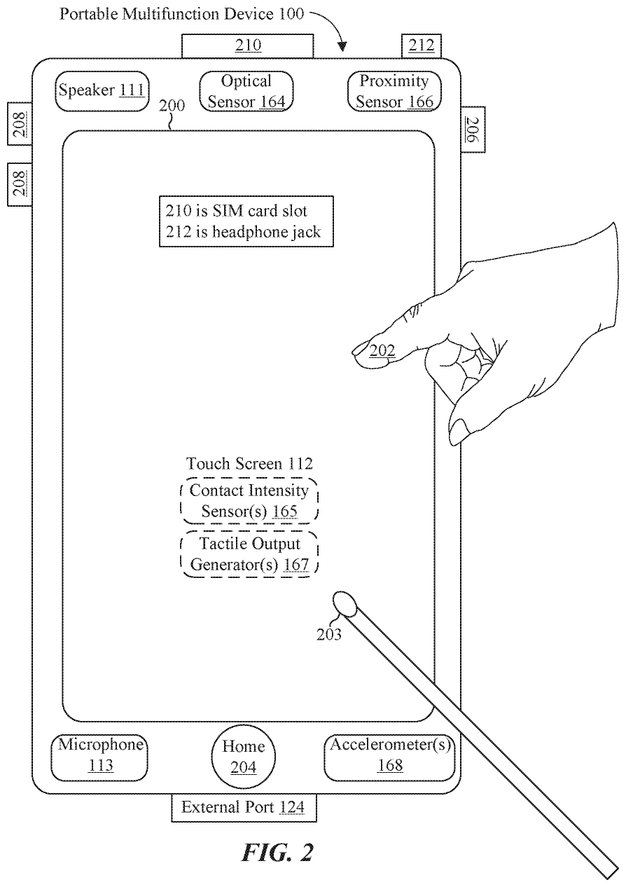

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Patents: U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

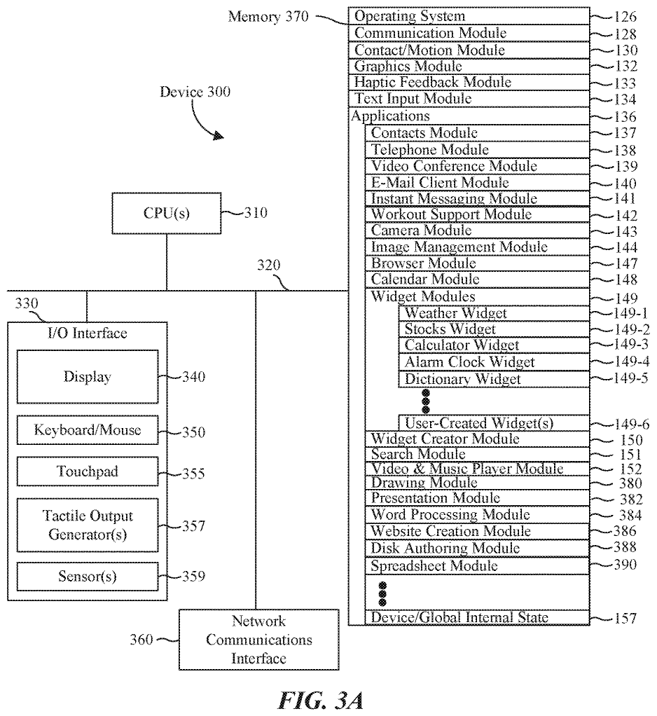

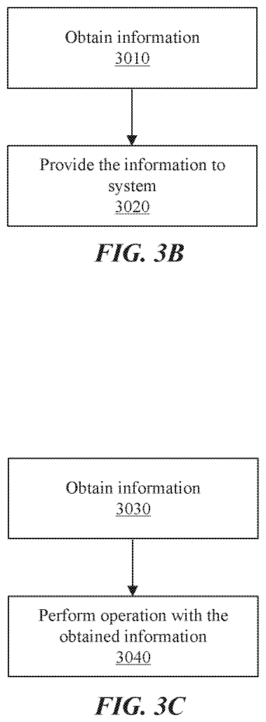

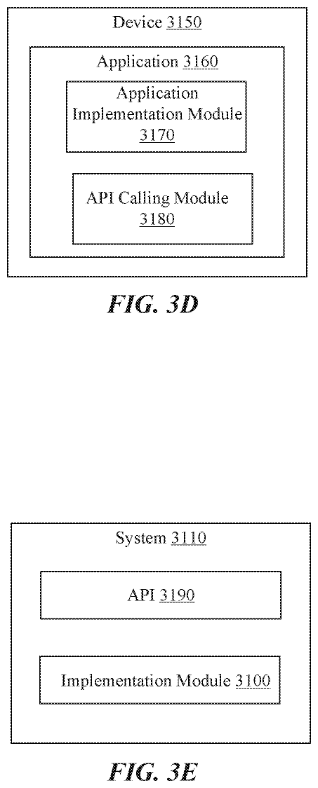

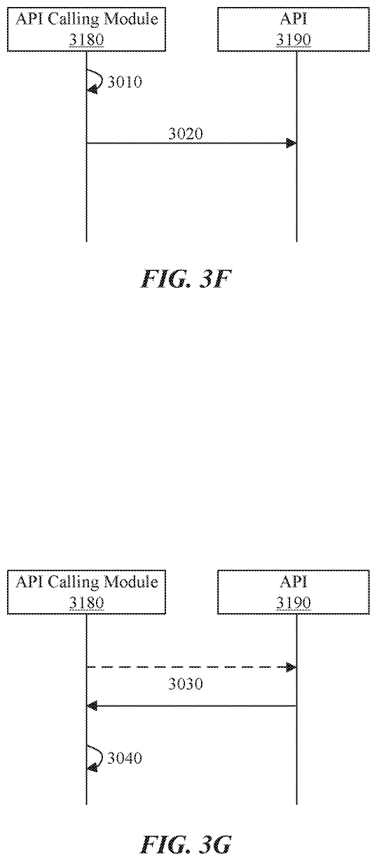

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online Video Module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the process of FIG. 3B, the process of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the process of FIG. 3B and/or the process of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the process of FIG. 3B and/or the process of FIG. 3C by calling an application programming interface (API) (e.g., API 3190) provided by system 3110. In some embodiments, application 3160 performs at least a portion of the process of FIG. 3B and/or the process of FIG. 3C without calling API 3190.

In some embodiments, one or more steps of the process of FIG. 3B and/or the process of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700 and/or 900 (FIGS. 7 and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

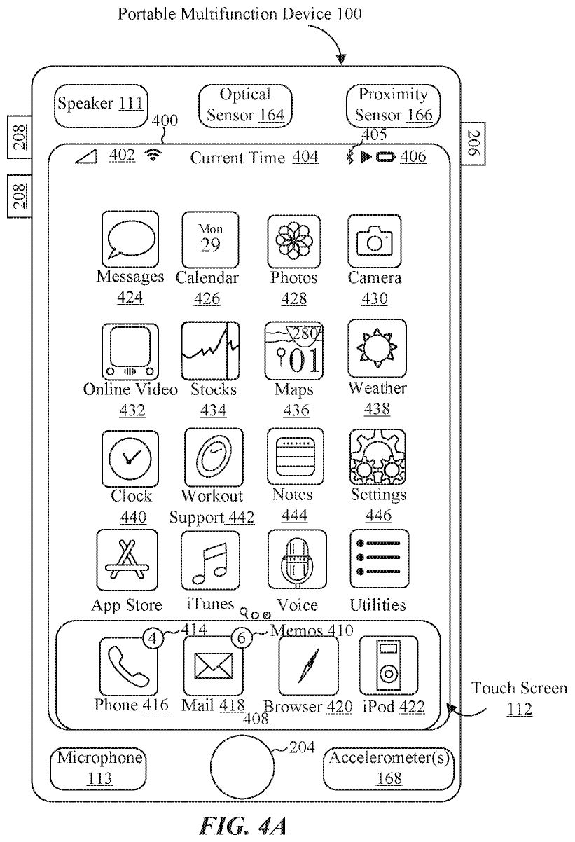

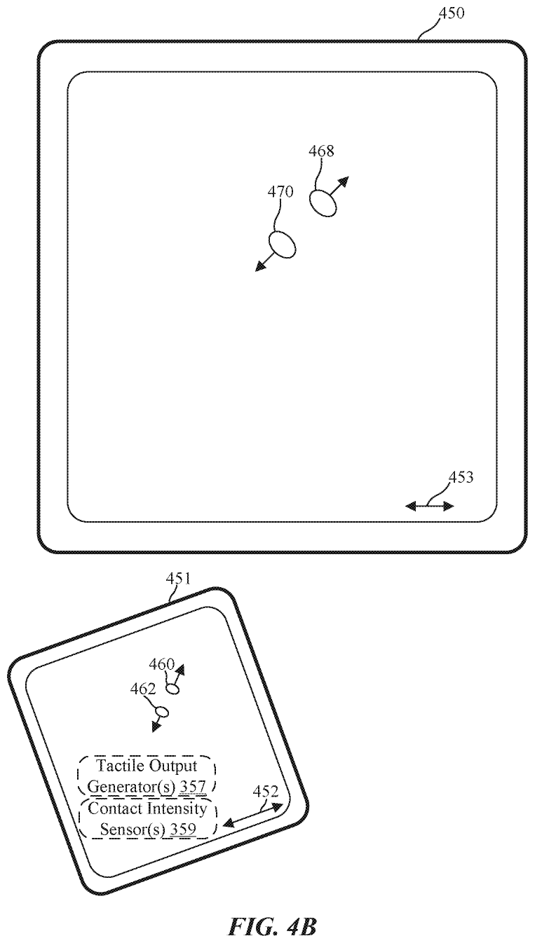

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIGS. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

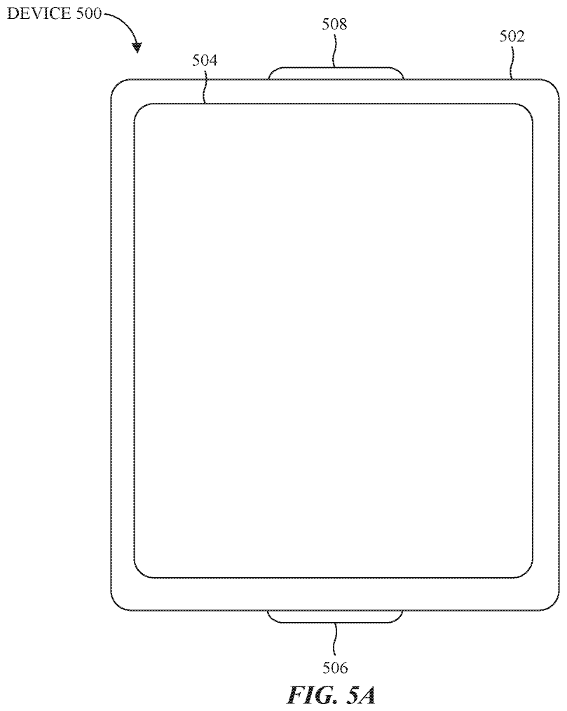

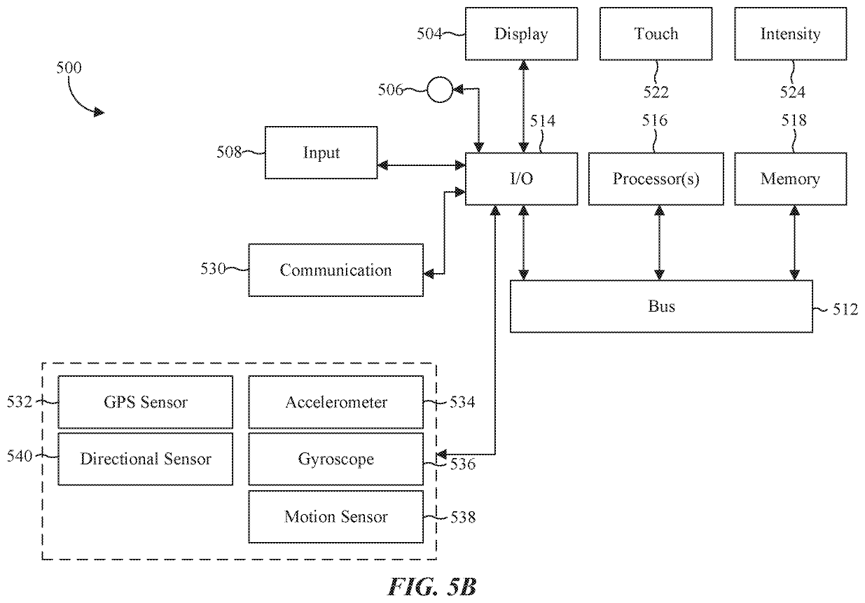

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and/or 900 (FIGS. 7 and/or 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6M illustrate exemplary user interfaces for managing settings in accordance with some embodiments. The user interfaces in these figures are used to illustrate the processes described below, including the processes in FIG. 7.

In some embodiments, managing settings includes a first computer system sending a set of one or more settings to a second computer system. In such embodiments, the set of one or more settings can be applied to the second computer system so that a user of the first computer system can operate the second computer system with their familiar set of one or more settings. In some embodiments, the set of one or more settings includes personalized and/or accessibility settings to aid a user of the first computer system in using the second computer system. In some embodiments, the second computer system is not logged into an account of or associated with the user of the first computer system. In such embodiments, the user of the first computer system is able to use the second computer system with the same settings as their own computer system.

FIGS. 6A-6M illustrate computer system 600 as a smart phone. It should be recognized that computer system 600 can be other types of computer systems such as a tablet, a smart watch, a laptop, a communal device, a smart speaker, an accessory, a personal gaming system, a desktop computer, a fitness tracking device, and/or a head-mounted display (HMD) device. FIGS. 6A-6M illustrate computer system 602 as a smart phone. It should be recognized that computer system 602 can be other types of computer systems such as a tablet, a smart watch, a laptop, a communal device, a smart speaker, an accessory, a personal gaming system, a desktop computer, a fitness tracking device, and/or a head-mounted display (HMD) device. FIGS. 6A-6M illustrate computer system 636 as a laptop. It should be recognized that computer system 636 can be other types of computer systems such as a tablet, a smart watch, a smart phone, a communal device, a smart speaker, an accessory, a personal gaming system, a desktop computer, a fitness tracking device, and/or a head-mounted display (HMD) device. In some embodiments, computer system 636 is a communal computer system that is used by many different users without requiring each user to be logged into the communal computer system. For example, the communal computer system can be a tablet for displaying a map of a location or a desktop at a public library. In some embodiments, computer system 600, computer system 602, and/or computer system 636 include and/or are in communication with one or more input devices (e.g., a sensor, a camera, a lidar detector, a motion sensor, an infrared sensor, a touch-sensitive surface, a physical input mechanism, and/or a microphone). In some embodiments, computer system 600, computer system 602, and/or computer system 636 include and/or are in communication with one or more output devices (e.g., a display screen, a projector, a touch-sensitive display, and/or a speaker). In some embodiments, computer system 600, computer system 602, and/or computer system 636 include one or more components and/or features described above in relation to portable multifunction device 100, device 300, or device 500.

FIGS. 6A-6I and FIGS. 6K-6M are split between a left side and a right side to illustrate two separate computer systems. FIGS. 6A-6I and FIGS. 6K-6M illustrate computer system 600 on the left side. FIGS. 6A-6I illustrate computer system 602 on the right side and FIGS. 6K-6M illustrate computer system 636 on the right side. While FIGS. 6A-6M illustrate computer system 600, computer system 602, and computer system 636 outputting particular content, it should be recognized that such content is merely for explanatory purposes and that such content can be in different forms, at different locations, at different sizes, include different content, and/or that more, fewer, and/or different content can be output in accordance with techniques described herein.

While the examples in FIGS. 6A-6M include computer system 600, computer system 602, and computer system 636 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras.

FIGS. 6A-6M illustrate computer system 600 transferring a set of one or more settings to another computer system (e.g., computer system 602 or computer system 636). In some embodiments, computer system 600 transfers the set of one or more settings in response to detecting the other computer system within proximity of computer system 600 (e.g., 1-3 feet). It should be recognized that computer system 600 can transfer the set of one or more settings in response to other events, such as in response to computer system 600 detecting an input corresponding to a request to transfer the set of one or more settings or in response to detecting the other computer system sending a request to obtain the set of one or more settings. In some embodiments, computer system 600 transfers the set of one or more settings through a shared network with the other computer system. Upon receiving the set of one or more settings, the other computer system alters output of user interfaces and/or user interface elements according to the set of one or more settings. For example, the other computer system can alter a color, a shape, and/or a size of user interfaces and/or user interface elements output via the other computer system.

As illustrated in FIG. 6A, computer system 600 displays home screen user interface 604 including application icons according to the set of one or more settings of computer system 600. The set of one or more settings of computer system 600 is the set of one or more settings that the user of computer system 600 (e.g., John) has manually personalized. For example, computer system 600 displays home screen user interface 604 and the application icons with personalized colors and sizes and audibly narrates what computer system 600 is displaying. That is, the set of one or more settings of computer system 600 illustrated in FIG. 6A is not a default set of one or more settings of computer system 600, but rather are settings that John has added and can change. For example, home screen user interface 604 is illustrated with a hatching pattern, indicating that computer system 600 is displaying home screen user interface 604 with a lower level brightness as a result of a setting of the set of one or more settings. For another example, home screen user interface 604 includes text and icons for applications within home screen user interface 604 as enlarged as compared to a default setting of computer system 600. At FIG. 6A, the set of one or more settings also cause computer system 600 to output audio content 606, “Your device is displaying the home screen.” In some embodiments, the output of audio content 606 corresponds to a setting of the set of one or more settings to narrate what is displayed. In some embodiments, output of audio content corresponds to a setting of the set of one or more settings to narrate notifications received by computer system 600. In some embodiments, output of audio content corresponds to a setting of the set of one or more settings to narrate messages received by computer system 600. It should be recognized that such examples of settings are merely for explanatory purposes and the set of one or more settings of home screen user interface 604 can include other settings, such as inverted colors and/or increased contrast.

At FIG. 6A, while displaying home screen user interface 604, computer system 600 detects input 605a1. Input 605a1 is illustrated as a tap input on settings application control 610. It should be recognized that other input types can be used. For example, while displaying home screen user interface 604, computer system 600 can detect a verbal input requesting that computer system 600 open the settings application. For another example, while displaying home screen user interface 604, computer system 600 can detect a click input on settings application control 610.

As illustrated in FIG. 6A, computer system 602 displays notes user interface 608. Notes user interface 608 includes default colors, shapes, and text sizes of computer system 602 and computer system 602 does not narrate what is displayed (e.g., as described above with respect to computer system 600). That is, at FIG. 6A, computer system 602 includes a different set of one or more settings than those applied to computer system 600.

At FIG. 6A, while displaying notes user interface 608, computer system 602 detects input 605a2. Input 605a2 is illustrated as a swipe up input on a bottom edge of notes user interface 608. It should be recognized that one or more other input types can be used. For example, while displaying notes user interface 608, computer system 602 detects a verbal input requesting that computer system 602 close the notes application. For another example, while displaying notes user interface 608, computer system 602 detects an air gesture input in a waving motion.

As illustrated in FIG. 6B, in response to detecting input 605a1, computer system 600 displays settings user interface 612. At FIG. 6B, settings user interface 612 includes the set of one or more settings applied to computer system 600. Settings user interface 612 includes title indicator 612a, “Display Text and Size,” horizontal text indicator 612b, and invert indicator 612d. Title indicator 612a indicates that settings user interface 612 involves settings of the set of one or more settings related to text displayed by computer system 600. Horizontal text indicator 612b and invert indicator 612d are specific settings related to text displayed by computer system 600. As indicated by the positions and hatching of slider control 612c (e.g., corresponding to horizontal text indicator 612b) and slider control 612e (e.g., corresponding to invert indicator 612d), horizontal text indicator 612b and invert indicator 612d are in an on state. At FIG. 6B, computer system 600 displays user interfaces and user interface elements with the corresponding set of one or more settings including personalized colors, sizes, and/or patterns in response to detecting that horizontal text indicator 612b and invert indicator 612d are in an on state. Note that computer system 600 displays settings user interface 612 and controls included in settings user interface 612 as hatched, indicating the set of one or more settings are applied in the on state.

At FIG. 6B, while displaying settings user interface 612, computer system 600 detects input 605b1. Input 605b1 is illustrated as a swipe down input on a top edge of settings user interface 612. It should be recognized that one or more other input types can be used. For example, while displaying settings user interface 612, computer system 600 can detect a verbal input requesting that computer system 600 cease display of settings user interface 612. For another example, while displaying settings user interface 612, computer system 600 can detect an air gesture input in a dragging motion.

As illustrated in FIG. 6B, in response to detecting input 605a2, computer system 602 displays home screen user interface 614. Similar to notes user interface 608, computer system 602 displays home screen user interface 614 with default colors, shapes, and text sizes of computer system 602 and does not narrate what is displayed. That is, at FIG. 6B, computer system 602 is not operating with the set of one or more settings of computer system 600.

At FIG. 6B, while displaying home screen user interface 614, computer system 602 detects input 605b2. Input 605b2 is illustrated as a tap input on settings application control 610. It should be recognized that one or more other input types can be used. For example, while displaying home screen user interface 614, computer system 602 can detect a verbal input requesting that computer system 602 open the settings application. For another example, while displaying home screen user interface 614, computer system 602 can detect a pinch input toward application control 610.

As illustrated in FIG. 6C, in response to detecting input 605b1, computer system 600 displays controls menu 616. Controls menu 616 provides access to various controls of computer system 600, including music, brightness, sound, timers, camera, and network settings. Controls menu 616 also includes accessibility control 616a which is a control that provides access to accessibility functionalities of computer system 600. Note that computer system 600 displays controls menu 616 and controls included in controls menu 616 as hatched, indicating a personalized color and/or pattern.

At FIG. 6C, while displaying controls menu 616, computer system 600 detects input 605c1. Input 605c1 is illustrated as a tap input on accessibility control 616a. It should be recognized that one or more other input types can be used. For example, while displaying controls menu 616, computer system 600 can detect a verbal input requesting that computer system 600 display a user interface related to accessibility functionalities. For another example, while displaying notes user interface 608, computer system 600 can detect a pinch input toward accessibility control 616a.

As illustrated in FIG. 6C, in response to detecting input 605b2, computer system 602 displays settings user interface 612. Settings user interface 612 that computer system 602 displays at FIG. 6B is the same user interface that computer system 600 displays at FIG. 6B. However, because the set of one or more settings of computer system 602 have not been personalized (e.g., “default settings”) or have been personalized to computer system 602, computer system 602 displays settings user interface 612 with default colors, sizes, and patterns. Also illustrated on the right side of FIG. 6C, computer system 602 displays slider control 612c (e.g., corresponding to horizontal text indicator 612b) and slider control 612e (e.g., corresponding to invert indicator 612d) in an off state. Slider control 612c and slider control 612e in an off state further indicate that the set of one or more settings of computer system 602 have not been personalized and that computer system 602 is displaying default settings.

At FIG. 6C, while displaying settings user interface 612, computer system 602 detects input 605c2. Input 605c2 is illustrated as a swipe up input on a bottom area of settings user interface 612. It should be recognized that one or more other input types can be used. For example, while displaying settings user interface 612, computer system 602 can detect a verbal input requesting that computer system 602 cease display of settings user interface 612. For another example, while displaying notes user interface 608, computer system 602 can detect an air gesture input in a waving motion.

As illustrated in FIG. 6D, in response to detecting input 605c1, computer system 600 displays share user interface element 618 overlaid over controls menu 616. Share user interface element 618 is a user interface element that computer system 600 displays as part of a process of sharing the set of one or more settings with an external nearby computer system. Share user interface element 618 includes device indicator 618a, “Jane's Phone” and Jane icon 618b. Device indicator 618a indicates that a computer system named “Jane's Phone” (e.g., computer system 602) is within proximity to computer system 600 and Jane icon 618b is a representation of Jane (e.g., an animated face, a profile picture, or the initials of Jane). Share user interface element 618 also includes instructions 618c which are instructions describing how to connect computer system 600 and computer system 602 to share the set of one or more settings (e.g., “ . . . hold the top of this phone to another phone.”). Share user interface element 618 also includes device name 618d, “Appear as John's Phone” and John icon 618e. Device name 618d indicates that computer system 602 will display the settings that computer system 600 will transfer to computer system 602 as coming from “John's Phone.” John icon 618e is a representation of John (e.g., an animated face, a profile picture, or the initials of John). It should be recognized that proximity is one technique for sharing settings and that other techniques can be used, such as sending via a text message and/or sending using a wireless communication channel that does not require proximity.

As illustrated in FIG. 6D, in response to detecting input 605c2, computer system 602 displays home screen user interface 614. Computer system 602 displays home screen user interface 614 with default colors, shapes, and text sizes of computer system 602 and does not narrate what is displayed.

At a time between FIG. 6D and FIG. 6E, computer system 600 is placed within proximity of computer system 602. At FIG. 6E, in response to detecting computer system 602 within proximity to computer system 600, computer system 600 sends a request to computer system 602 to share the set of one or more settings. As part of sending the request, computer system 600 ceases display of share user interface element 618 and redisplays settings user interface 612 as illustrated in FIG. 6B. In other embodiments, computer system 600 maintains display of share user interface element 618 until the set of one or more settings are sent or until a user of computer system 600 dismisses share user interface element 618.

As illustrated in FIG. 6E, in response to receiving the request from computer system 600 to share the set of one or more settings, computer system 602 displays notification 620 overlaid over home screen user interface 614. Notification 620 is a notification that computer system 602 displays in order for a user of computer system 602 (e.g., Jane) to accept or deny the transfer of the set of one or more settings from computer system 600. Notification 620 includes title indicator 620a, “Accessibility,” prompt 620b, decline control 620c, and accept control 620d. Prompt 620b informs Jane that a nearby device would like to transfer the set of one or more settings to computer system 602. Decline control 620c and accept control 620d are controls with which Jane can accept or deny the transfer of the set of one or more settings. In some embodiments, computer system 602 maintains display of notification 620 until an input is detected on accept control 620d or decline control 620c. In some embodiments, computer system 602 maintains display of notification 620 until a threshold period of time (e.g., 5 seconds to 2 minutes) passes or computer system 600 dismisses notification 620 (e.g., in response to a swipe up on notification 620 or an input outside of notification 620).

At FIG. 6E, while displaying notification 620, computer system 602 detects input 605e. Input 605e is illustrated as a tap input on accept control 620d. It should be recognized that one or more other input types can be used. For example, while displaying notification 620, computer system 602 can detect a verbal input requesting that computer system 602 accept the transfer of the set of one or more settings. For another example, while displaying notification 620 computer system 602 can detect a pinch input toward accept control 620d

As illustrated in FIG. 6F, in response to detecting input 605e, computer system 602 accepts the transferred set of one or more settings and activates a sharing session. Computer system 602 indicates the activation of the sharing session by displaying bubble indicator 622 surrounding time indicator 624. Computer system 602 further indicates the activation of the sharing session by displaying John icon 618e within notification region 626. Computer system 602 displaying John icon 618e signifies that computer system 602 is currently operating under the set of one or more settings from John's phone (e.g., computer system 600). In some embodiments, if computer system 602 does not include notification region 626, computer system 602 maintains display of bubble indicator 622 to indicate the activation of the sharing session. In some embodiments, if computer system 602 does include notification region 626, computer system 602 does not display bubble indicator 622. It should be recognized that the sharing session being active can be indicated in other ways.

Also illustrated in FIG. 6F, in response to detecting the activation of the sharing session, computer system 602 alters display of home screen user interface 614 to apply the transferred set of one or more settings. At FIG. 6F, computer system 602 alters the display of home screen user interface 614 according to the set of one or more settings of computer system 600. For example, similar to as illustrated and described with respect to the set of one or more settings applied to computer system 600 at FIG. 6A, computer system 602 displays home screen user interface 614 and the applications within home screen user interface 614 with personalized colors and/or patterns, displays the text and applications within home screen user interface 614 as enlarged, and audibly narrates what computer system 602 is displaying. Computer system 602 audibly narrating what computer system 602 is displaying is indicated by audio output 628 (e.g., “Your device is displaying the home screen.”).

In some embodiments, while computer system 600 transfers the set of one or more settings described above, computer system 600 does not transfer all settings within the set of one or more settings. For example, computer system 600 does not transfer layouts across similar user interfaces. In such an example, computer system 600 at FIG. 6A displays home screen user interface 614 with a unique arrangement of applications including a calendar widget. After computer system 602 accepts the transferred set of one or more settings, computer system 602 does not alter home screen user interface 614 as illustrated in FIG. 6F compared to the arrangement of applications that computer system 600 displays as illustrated in FIG. 6A. For example, computer system 602 displays a unique arrangement of applications within home screen application 614 that is different from home screen application 614 as displayed by computer system 600 at FIG. 6A. For another example, computer system 600 does not transfer modes. For example, if computer system 600 is in a dark mode setting while transferring the set of one or more settings to computer system 602 while computer system 602 is in a light mode setting, computer system 600 does not transfer the dark mode setting to computer system 602. In such an example, after receiving and accepting the transferred set of one or more settings from computer system 600, computer system 602 is still in the light mode.

At FIG. 6F, while displaying home screen user interface 614, computer system 602 detects input 605f. Input 605f is illustrated as a tap input on notes application control 630. It should be recognized that one or more other input types can be used. For example, while displaying home screen user interface 614, computer system 602 can detect a verbal input requesting that computer system 602 open the notes application. For another example, computer system 602 can detect a pinch input toward notes application control 630. As illustrated in FIG. 6F, computer system 600 maintains display of settings user interface 612.

As illustrated in FIG. 6G, in response to detecting input 605f, computer system 602 displays notes user interface 608 similarly to as illustrated in FIG. 6A. However, computer system 602 displays notes user interface 608 at FIG. 6G with an altered appearance based on the transferred set of one or more settings from computer system 600. For example, computer system 600 displays the background of notes user interface 608 with a color and/or pattern as indicated by the hatching. For another example, computer system 602 displays the text within notes user interface 608 as enlarged as compared to the default text size of computer system 600 as illustrated in FIG. 6A. For another example, computer system 602 outputs audio content 632 (e.g., “Notes application. Your grocery list includes eggs, milk, and butter.”) narrating what computer system 602 is displaying. In some embodiments, computer system 602 is displaying the default version of notes user interface 608 at the time that computer system 602 accepts the transferred set of one or more settings. In such embodiments, in response to detecting computer system accepting the transferred set of one or more settings, computer system alters notes user interface 608 from as illustrated in FIG. 6A to notes user interface 608 as illustrated in FIG. 6G.

At FIG. 6G, while displaying notes user interface 608, computer system 602 detects input 605g1. Input 605g1 is illustrated as a tap input on John icon 618e within notification region 626. It should be recognized that one or more other input types can be used. For example, while displaying notes user interface 608, computer system 602 can detect a verbal input requesting that computer system 602 end the sharing session. For another example, computer system 602 can detect a pinch input toward John icon 618e.

In some embodiments, while displaying notes user interface 608, computer system 602 detects input 605g2. Input 605g2 is illustrated as a tap input on bubble indicator 622 surrounding time indicator 624. It should be recognized that one or more other input types can be used. For example, while displaying notes user interface 608, computer system 602 can detect a verbal input requesting that computer system 602 end the sharing session. For another example, computer system 602 can detect a pinch input toward bubble indicator 622. As illustrated in computer system 600 maintains display of settings user interface 612.

As illustrated on the right side of FIG. 6H, in response to detecting either input 605g1 or input 605g2, computer system 602 displays notification 634 overlaid over notes user interface 608. Notification 634 is a notification that computer system 602 displays as an option to end the sharing session. Notification 634 includes prompt 634a, which informs Jane that ending the sharing session will restore the default settings of computer system 602. Notification 634 also includes cancel control 634b and OK control 634c. It should be recognized that notification 634 is one example of how cancel control 634b and OK control 634c can b provided and that such controls can be provided in other manners, such as being included within notification region 626 before or after detecting input 605g2.

At FIG. 6H, while displaying notification 634, computer system 602 detects input 605h. Input 605h is illustrated as a tap input on OK control 634c. It should be recognized that one or more other input types can be used. For example, while displaying notification 634, computer system 602 can detect a verbal input confirming that Jane would like to end the sharing session. For another example, computer system 602 can detect a pinch input toward OK control 634c. As illustrated in FIG. 6H, computer system 600 maintains display of settings user interface 612.

As illustrated in FIG. 6I, in response to detecting input 605h, computer system 602 reverts display of notes user interface 608 to the default settings that computer system 602 displayed as illustrated in FIG. 6A. For example, computer system 602 shrinks the size of the text within notes user interface 608 and ceases display of the color and/or pattern of the background of notes user interface 608. As also illustrated in FIG. 6I, computer system 602 ceases display of John icon 618e and bubble indicator 622, which indicates that computer system 602 has ended the sharing session. As illustrated in FIG. 6I, computer system 600 maintains display of settings user interface 612.

In some embodiments, computer system 602 reverts back to the default settings of computer system 602 in response to an action other than detecting an input on either input 605g1 or input 605g2. For example, in response to detecting computer system 602 displaying notification 634, computer system 602 reverts to default settings before and/or without detecting an input to confirm cancellation of the sharing session (e.g., input 605h). For another example, in response to detecting an input to lock computer system 602, computer system 602 reverts to default settings before and/or without detecting an input to confirm cancellation of the sharing session (e.g., input 605h). In such an example, in response to detecting an input to lock computer system 602, computer system 602 automatically ends the sharing session. For example, while displaying notes user interface 608 as illustrated in FIG. 6H, computer system 602 detects Jane locking computer system 602. In response to detecting Jane unlocking computer system 602, computer system 602 will display the default settings and not the set of one or more settings that were transferred from computer system 600. For another example, in response to detecting computer system 600 go beyond a proximity from computer system 602, computer system 602 reverts back to default settings before and/or without detecting an input to confirm cancellation of the sharing session (e.g., input 605h). For another example, in response to detecting computer system 602 go beyond a proximity from computer system 600, computer system 602 reverts back to default settings before and/or without detecting an input to confirm cancellation of the sharing session (e.g., input 605h).

Although the above describes applying one set of one or more settings from computer system 600, in some embodiments, an additional set of one or more settings may be received and applied by computer system 602. For example, computer system 602, after displaying notes user interface 608 and home screen user interface 614 with the set of one or more settings from computer system 600, receives a request to initiate a sharing session with another computer system different from computer system 600. In response to initiating the sharing session, computer system 602 displays user interfaces such as home screen user interface 614 and/or notes user interface 608 with the received set of one or more settings. In some embodiments, the received set of one or more settings from the other computer system are different from the set of one or more settings received from computer system 600. For example, the set of one or more settings received from computer system 600 include settings for computer system 602 to display the corresponding user interfaces with no narration of the display and smaller text and applications. By being able to apply sets of one or more settings from different computer systems, computer system 602 can be used by many other users with the comfort and/or ability that they have with their own computer system.

At FIG. 6I, while displaying settings user interface 612, computer system 600 detects input 605i. Input 605i is illustrated as a swipe down input on a top edge of settings user interface 612. It should be recognized that one or more other input types can be used. For example, while displaying settings user interface 612, computer system 600 can detect a verbal input requesting that computer system 600 cease display of settings user interface 612. For another example, computer system 600 can detect an air gesture input in a waving motion.

At a time between FIGS. 6I and 6J, computer system 602 goes beyond the proximity from computer system 600 and is therefore not illustrated in FIG. 6J. As illustrated in FIG. 6J, in response to detecting input 605i, computer system 600 displays controls menu 616, as illustrated in FIG. 6C. At FIG. 6J, while displaying controls menu 616, computer system 600 detects input 605j. Input 605j is illustrated as a tap input on accessibility control 616a. It should be recognized that one or more other input types can be used. For example, while displaying controls menu 616, computer system 600 can detect a verbal input requesting that computer system 600 display a user interface related to accessibility functionalities. For another example, computer system 600 can detect a pinch input toward accessibility control 616a.

At a time between FIGS. 6J and 6K, computer system 636 comes within proximity to computer system 600. As discussed above, computer system 636 is illustrated as a laptop. As illustrated in FIG. 6K, computer system 636 displays home screen user interface 638. Home screen user interface 638 includes image 638a and files 638b among other user interface elements. At FIG. 6K, computer system 636 displays home screen user interface 638 with default colors, shapes, and text sizes of computer system 636. That is, at FIG. 6K, computer system 636 exhibits different settings from the set of one or more settings.

As illustrated in FIG. 6K, in response to detecting input 605j, computer system 600 displays share user interface element 618 overlaid over controls menu 616, similarly to as illustrated and described with respect to FIG. 6D. At FIG. 6K, share user interface element 618 includes device indicator 618f, “Jane's Laptop,” and laptop icon 618g. Device indicator 618f indicates that computer system 636 is named “Jane's Laptop” and is within proximity to computer system 600. Laptop icon 618g is a representation of computer system 636. Share user interface element 618 also includes device name 618d, “Appear as John's Phone” and John icon 618e. Device name 618d indicates that computer system 636 will display the settings that computer system 600 will transfer to computer system 636 as coming from “John's Phone.”

At FIG. 6K, while displaying share user interface element 618, computer system 600 detects input 605k. Input 605k is illustrated as a tap input on laptop icon 618g. It should be recognized that one or more other input types can be used. For example, while displaying share user interface element 618, computer system 600 can detect a verbal input requesting that computer system 600 send a request to computer system 636 to share the set of one or more settings. For another example, computer system 600 can detect a pinch input toward laptop icon 618g.

At FIG. 6L, in response to detecting input 605k, computer system 600 sends a request to computer system 636 to share set of one or more settings. As part of sending the request, computer system 600 ceases display of share user interface element 618 and redisplays settings user interface 612 as illustrated and described with respect to FIG. 6I.

As illustrated in FIG. 6L, in response to receiving the request from computer system 600 to share set of one or more settings, computer system 636 displays notification 640 overlaid over home screen user interface 638. Notification 640 is a notification that computer system 636 displays in order for the user of computer system 636 (e.g., Jane) to accept or deny the transfer of the set of one or more settings from computer system 600, similar to notification 620 as illustrated and described with respect to FIG. 6E. Notification 640 includes decline control 640a and accept control 640b. Decline control 640a and accept control 640b are controls with which Jane can accept or deny the transfer of set of one or more settings.

At FIG. 6L, while displaying notification 640, computer system 636 detects input 605l. Input 605l is illustrated as a click input on accept control 640b. At FIG. 6L, Jane performs input 605l via a click input on touchpad 648, as indicated by a second representation of input 605l on touchpad 648. The selection of accept control 640b is also illustrated by cursor 646 hovering above accept control 640b. It should be recognized that one or more other input types can be used. For example, while displaying notification 640, computer system 636 can detect a verbal input requesting that computer system 636 accept the transfer of the set of one or more settings. For another example, computer system 636 can detect a pinch input toward accept control 640b. As illustrated in FIG. 6L, computer system 600 maintains display of settings user interface 612.

As illustrated in FIG. 6M, in response to detecting input 605l, computer system 636 accepts the transferred set of one or more settings and activates a sharing session. Also illustrated in FIG. 6M, in response to the activation of the sharing session, computer system 636 alters display of home screen user interface 638. At FIG. 6M, computer system 636 alters the display of home screen user interface 638 according to the set of one or more settings of computer system 600. For example, computer system 636 enlarges the size of text within home screen user interface 638, image 638a, and files 638b. For another example, computer system 600 displays home screen user interface 638 with personalized colors and/or patterns (e.g., as indicated by the hatching) and audibly narrates what computer system 636 is displaying. Computer system 636 audibly narrating what computer system 636 is displaying is indicated by audio output 642 (e.g., “Desktop is displayed.”).

In some embodiments, computer system 636 applies the transferred set of one or more settings differently than computer system 602. For example, computer system 600 is a phone and computer system 636 is a laptop and are therefore different types of computer systems. In some embodiments, the phone (e.g., computer system 600) sends to the laptop (e.g., computer system 636) some settings that correspond to the type of computer system. For example, computer system 600 does not send to computer system 636 the setting of the set of one or more settings of enlarging the size of text because computer system 636 has a bigger screen than computer system 600 so the text is easier to read. For another example, computer system 600 does not send to computer system 636 the setting of the set of one or more settings of eye tracking or voice commands from computer system 600 to computer system 636 (e.g., a laptop) because the transfer may require training that has not been completed or requires data that is secure and cannot be shared. In some embodiments, computer system 636 selectively implements certain settings of the set of one or more settings received. For example, computer system 600 sends to computer system 636 all of the set of one or more settings (e.g., the same set of one or more settings as what was sent to similar type computer systems such as computer system 602). For example, computer system 636 receives the setting of the set of one or more settings to enlarge text and does not apply the setting because of the difference in type of computer systems (e.g., difference between computer system 600 and computer system 636).

As illustrated in FIG. 6M, computer system 636 displays notification 644 including end control 644a which can end the sharing session. In some embodiments, in response to detecting an input on end control 644a, computer system 636 ends the sharing session and reverts the display of home screen user interface 638 to default settings of computer system 636 as illustrated in FIG. 6K. As illustrated in FIG. 6M, computer system 600 maintains display of settings user interface 612.

In some embodiments, computer system 636 displays an indication that the sharing session is active. For example, computer system 636 displays John icon 618e and/or bubble indicator 622 on home screen user interface 638 to indicate the sharing session is active. In some embodiments, in response to detecting an input on John icon 618e and/or bubble indicator 622, computer system 636 displays notification 644. In some embodiments, computer system 636 displays notification 644 to indicate the sharing session is active.

FIG. 7 is a flow diagram illustrating a process (e.g., process 700) for sharing a set of one or more settings in accordance with some embodiments. Some operations in process 700 are, optionally, combined, the orders of some operations are, optionally, changed, and some operations are, optionally, omitted.

As described below, process 700 provides an intuitive way for sharing a set of one or more settings in accordance with some embodiments. Process 700 reduces the cognitive burden on a user, thereby creating a more efficient human-machine interface. For battery-operated computing devices, enabling a user to interact with such devices faster and more efficiently conserves power and increases the time between battery charges. Providing improved feedback (such as by displaying a user interface with different appearances depending on settings received from another device) enhances the operability of the device by reducing accidental and mistaken inputs, reducing energy usage by the device. Displaying user interface elements with different appearances at different times (such as by displaying a user interface with different appearances depending on settings received from another device) helps to avoid image persistence or burn in effects that are can occur with some display technologies when the same object is displayed with the same appearance at the same location repeatedly or for a long period of time Providing additional control options without cluttering the UI with additional displayed controls (such as by enabling a device to pass settings to another device so that the other device operates with the settings of the device) enhances the operability of the device by reducing unnecessary inputs and/or steps to navigate through different user interfaces or sets of controls, reducing energy usage by the device. Performing an operation when a set of conditions has been met without requiring further user input (such as by displaying a user interface with different appearances depending on settings received from another device) enhances the operability of the device by reducing unnecessary inputs and/or steps to navigate through different user interfaces or sets of controls, reducing energy usage by the device.

In some embodiments, process 700 is performed at a first computer system (e.g., 602 and/or 636) that is in communication (e.g., wired communication and/or wireless communication) with (and/or includes) one or more display generation components (e.g., a display screen, a projector, a head mounted display, and/or a touch-sensitive display) and one or more input devices (e.g., a camera, a depth sensor, a microphone, a hardware input mechanism, a rotatable input mechanism, a heart monitor, a temperature sensor, and/or a touch-sensitive surface). In some embodiments, the first computer system is a phone, a watch, a tablet, a fitness tracking device, a wearable device, an accessory, a speaker, a light, a head-mounted display (HMD), and/or a personal computing device.

The first computer system displays (702), via the one or more display generation components, a user interface (e.g., 614 and/or 638) (e.g., a system user interface and/or an application user interface including one or more user interface elements) according to a first set of one or more settings (e.g., output settings and/or accessibility settings) (e.g., default set of one or more settings, such as described above with respect to FIGS. 6A, 6B, 6D, 6G, and 6K). In some embodiments, the user interface is a home screen, a user interface of an application, or a user interface of an operating system of the first computer system. In some embodiments, displaying the user interface according to the first set of one or more settings includes displaying the user interface in a first manner (e.g., emphasis, visual filter, and/or text scale). In some embodiments, the first manner is defined by the first set of one or more settings. In some embodiments, the user interface is displayed, based on the first set of one or more settings, while a first appearance.

While displaying the user interface according to the first set of one or more settings, the first computer system receives (704), from a second computer system (e.g., 600) different from the first computer system, a respective set of one or more settings (e.g., display settings, audio settings, haptic settings, output settings, and/or accessibility settings) (e.g., set of one or more settings, such as described above with respect to FIGS. 6A, 6B, 6D, 6G, and 6K) (and/or an indication of the respective set of one or more settings) (and/or initiating a share session, such as described above with respect to FIGS. 6F-6H and 6M). In some embodiments, the second computer system is a phone, a watch, a tablet, a fitness tracking device, a wearable device, an accessory, a speaker, a light, a head-mounted display (HMD), and/or a personal computing device.

In response to receiving the respective set of one or more settings, the first computer system displays (706), via the one or more display generation components, a user interface element (e.g., 620 and/or 64) (e.g., a virtual button, an icon, a widget, a control, and/or a window) to apply the respective set of one or more settings to the first computer system. In some embodiments, the user interface element is displayed with and/or on top of the user interface.

While displaying the user interface element to apply the respective set of one or more settings to the first computer system, the first computer system detects (708), via the one or more input devices, an input (e.g., 605e and/or 605l) (e.g., a tap input, a voice input, and/or an air gesture) corresponding to (e.g., directed to, at a location of, related to, and/or associated with) the user interface element to apply the respective set of one or more settings to the first computer system. In some embodiments, the tap input is on the user interface element to apply the respective set of one or more settings to the first computer system. In some embodiments, the voice input includes a request corresponding to the user interface element to apply the respective set of one or more settings to the first computer system (e.g., “Select yes,” and/or “Apply those settings,”). In some embodiments, the air gesture includes a gesture corresponding to a request to select the user interface element to apply the respective set of one or more settings to the first computer system (e.g., a pinch and/or swipe).

In response to (710) detecting the input corresponding to the user interface element to apply the respective set of one or more settings to the first computer system, in accordance with a determination that the respective set of one or more settings includes a first setting, the first computer system displays (712), via the one or more display generation components, the user interface with a first appearance (e.g., a set of one or more visual characteristics, such as color, shape, size, location, text size, and/or text font) (e.g., enlarged text, personalized colors, audibly narrating, such as described above with respect to FIGS. 6A, 6F, 6G, and/or 6M) according to the first setting.

In response to (710) detecting the input corresponding to the user interface element to apply the respective set of one or more settings to the first computer system, in accordance with a determination that the respective set of one or more settings includes a second setting (and/or does not include the first setting), the first computer system displays (714), via the one or more display generation components, the user interface with a second appearance (e.g., a set of one or more visual characteristics, such as color, shape, size, location, text size, and/or text font) (e.g., enlarged text, personalized colors, audibly narrating, such as described above with respect to FIGS. 6A, 6F, 6G, and/or 6M) according to the second setting (e.g., without displaying the user interface with the first appearance according to the first setting), wherein the second setting is different from the first setting, and wherein the second appearance is different from the first appearance.

In some embodiments, the respective set of one or more settings is received (and/or the user interface element is displayed) in conjunction with (e.g., while, in response to, and/or after) the first computer system being within proximity (e.g., a predefined distance, a required distance, and/or a distance) (e.g., such as described above with respect to FIGS. 6E and 6J-6K) of the second computer system. In some embodiments, the respective set of one or more settings are received via a wireless communication channel (e.g., NFC, Bluetooth, WiFi, and/or Thread) that requires the first computer system to be within proximity of the second computer system. In some embodiments, the wireless communication channel is a short-range wireless communication channel.

In some embodiments, the first set of one or more settings includes a third setting (e.g., enlarged text, personalized colors, audibly narrating, such as described above with respect to FIGS. 6A, 6F, 6G, and/or 6M) corresponding to (e.g., affecting, causing, resulting in, and/or associated with) an appearance of the user interface while displaying the user interface according to the first set of one or more settings. In some embodiments, the third setting is different from the first setting and/or the second setting. In some embodiments, the first setting corresponds to (e.g., affects, causes, results in, and/or associated with) the first appearance (e.g., and not the second appearance). In some embodiments, the first setting corresponds to (e.g., affects, causes, results in, and/or associated with) the second appearance (e.g., and not the first appearance).

In some embodiments, the first computer system is in communication (e.g., wired communication and/or wireless communication) with (and/or includes) one or more output devices (the one or more display generation components, one or more audio generation components, and/or one or more haptic generation components). In some embodiments, the one or more audio generation components include a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output. In some embodiments, before detecting the input corresponding to the user interface element to apply the respective set of one or more settings to the first computer system, the first computer system detects a first event (e.g., displaying a user interface and/or receiving a notification, such as described above with respect to FIG. 6A). In some embodiments, detecting the first event includes receiving, from a third computer system different from the first computer system and the second computer system, a notification, such as a text message, a call, or an email. In some embodiments, detecting the first event includes a first process of the computer system receiving, from a second process of the computer system, a message. In some embodiments, the second process is separate from the first process. In some embodiments, detecting the first event includes detecting, via the one or more input devices, an input, such as from a user. In some embodiments, detecting the first event includes detecting that a set of one or more criteria is satisfied, such as a time has expired for a timer. In some embodiments, in response to detecting the first event, the first computer system outputs, via the one or more output devices, a non-visual output (e.g., an audio output and/or a haptic output) (e.g., 606). In some embodiments, the non-visual output is output based on the respective set of one or more settings being active while detecting the first event. In some embodiments, the first set one or more settings includes a setting that configured the first computer system to output the non-visual output in response to detecting the first event. In some embodiments, after detecting the input corresponding to the user interface element to apply the respective set of one or more settings to the first computer system, the first computer system detects a second event (e.g., displaying a user interface and/or receiving a notification, such as described above with respect to FIG. 6A) separate from the first event, wherein the second event is the same type of event as the first event. In some embodiments, the second event is the same as the first event. In some embodiments, detecting the second event includes receiving, from a third computer system different from the first computer system and the second computer system, a notification, such as a text message, a call, or an email. In some embodiments, detecting the second event includes a first process of the computer system receiving, from a second process of the computer system, a message. In some embodiments, the second process is separate from the first process. In some embodiments, detecting the second event includes detecting, via the one or more input devices, an input, such as from a user. In some embodiments, detecting the first event includes detecting that a set of one or more criteria is satisfied, such as a time has expired for a timer. In some embodiments, in response to detecting the second event, the first computer system forgoes output of, via the one or more output devices, the non-visual output. In some embodiments, the non-visual output is not output based on the respective set of one or more settings being active while detecting the second event. In some embodiments, the respective set one or more settings includes a setting that configured the first computer system to not output the non-visual output in response to detecting the second event. In some embodiments, in response to detecting the second event, the first computer system outputs, via the one or more output devices, another non-visual output different from the non-visual output. In some embodiments, the other non-visual output is not output in response to detecting the first event. In some embodiments, the non-visual output is output in response to detecting the second event after detecting the input corresponding to the user interface element to apply the respective set of one or more settings to the first computer system and the non-visual output is not output in response to detecting the first event before detecting the input corresponding to the user interface element to apply the respective set of one or more settings to the first computer system.

In some embodiments, the second computer system is configured to operate according to (and/or is using, uses, and/or operates according to) the respective set of one or more settings while the respective set of one or more settings (and/or the indication of the respective set of one or more settings) is received by the first computer system (e.g., such as described above with respect to FIGS. 6D-6E).

In some embodiments, the user interface includes a first user interface element (e.g., an icon, a button, text, an image, a video, and/or a background) (e.g., such as described above with respect to FIGS. 6B and 6K) corresponding to a first application. In some embodiments, the user interface includes a second user interface element (e.g., an icon, a button, text, an image, a video, and/or a background) (e.g., such as described above with respect to FIGS. 6B and 6K) corresponding to a second application. In some embodiments, the second user interface element is different from the first user interface element. In some embodiments, the second application is different from the first application. In some embodiments, the first user interface element has a first appearance (e.g., color, shape, size, location, text size, and/or text font) (e.g., such as described above with respect to FIGS. 6B and 6K) before detecting the input corresponding to the user interface element to apply the respective set of one or more settings to the first computer system. In some embodiments, the first user interface element has a second appearance (e.g., color, shape, size, location, text size, and/or text font) (e.g., such as described above with respect to FIGS. 6B and 6K) in response to detecting the input corresponding to the user interface element to apply the respective set of one or more settings to the first computer system. In some embodiments, the second appearance is different from the first appearance. In some embodiments, the second user interface element has a third appearance (e.g., color, shape, size, location, text size, and/or text font) (e.g., such as described above with respect to FIGS. 6F and 6M) before detecting the input corresponding to the user interface element to apply the respective set of one or more settings to the first computer system. In some embodiments, the second user interface element has a fourth appearance (e.g., color, shape, size, location, text size, and/or text font) (e.g., such as described above with respect to FIGS. 6F and 6M) in response to detecting the input corresponding to the user interface element to apply the respective set of one or more settings to the first computer system. In some embodiments, the third appearance is different from the second appearance and the first appearance. In some embodiments, the fourth appearance is different from the third appearance, the second appearance, and the first appearance.

In some embodiments, before displaying the user interface according to the first set of one or more settings, the first computer system displays another user interface (e.g., 608) according to the first set of one or more settings, wherein the other user interface is separate (and/or different) from the user interface.

In some embodiments, the user interface is from a first application (e.g., note taking application such as described above with respect to FIG. 6A) (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application). In some embodiments, the other user interface is from a second application (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application). In some embodiments, the second application is different from the first application. In some embodiments, the user interface is from the same application as the other user interface.

In some embodiments, while the first computer system is configured according to the first set of one or more settings, the first computer system detects, via the one or more input devices, an input (e.g., proximity of the computer system, such as described above with respect to FIG. 6L) corresponding to a request to share the first set of one or more settings (e.g., with another computer system in proximity with the first computer system). In some embodiments, in response to detecting the input corresponding to the request to share the first set of one or more settings, in accordance with a determination to share the first set of one or more settings with a computer system of a first type (e.g., such as described above with respect to FIG. 6M) (e.g., a selected computer system and/or a nearby computer system is a computer system of the first type), the first computer system sends a first subset of settings of the first set of one or more settings. In some embodiments, a computer system of the first type is a phone, a wearable device, a laptop, a desktop, or a particular model of a phone, a wearable device, a laptop, or a desktop. In some embodiments, the first subset is sent to the computer system of the first type. In some embodiments, the first subset is sent via a particular communication channel, such as a short-range wireless communication channel (e.g., NFC, Bluetooth, WiFi, and/or Thread). In some embodiments, the first subset is the first set of one or more settings. In some embodiments, in response to detecting the input corresponding to the request to share the first set of one or more settings, in accordance with a determination to share the first set of one or more settings with a computer system of a second type (e.g., such as described above with respect to FIG. 6M) (e.g., a selected computer system and/or a nearby computer system is a computer system of the second type), the first computer system sends a second subset (e.g., without sending the first subset) of settings of the first set of one or more settings, wherein the second subset is different from the first subset. In some embodiments, the second subset is sent to the computer system of the second type. In some embodiments, the second subset is sent via a particular communication channel, such as a short-range wireless communication channel (e.g., NFC, Bluetooth, WiFi, and/or Thread).

In some embodiments, the respective set of one or more settings includes a setting configured to be applied to a computer system of a first type (e.g., such as described above with respect to FIG. 6M) (e.g., a phone, a wearable device, a laptop, a desktop, or a particular model of a phone, a wearable device, a laptop, or a desktop). In some embodiments, the respective set of one or more settings includes a setting configured to be applied to a computer system of a second type (e.g., such as described above with respect to FIG. 6M) (e.g., a phone, a wearable device, a laptop, a desktop, or a particular model of a phone, a wearable device, a laptop, or a desktop). In some embodiments, the setting configured to be applied to a computer system of the second type is different (and/or separate) from the setting configured to be applied to a computer system of the first type. In some embodiments, a computer system of the second type is different from a computer system of the first type. In some embodiments, different settings of the respective set of one or more settings apply to different types of computer systems though all the respective set of one nor more settings are sent to any computer system. In some embodiments, in response to receiving the respective set of one or more settings, the first computer system configures itself according to some but not all of the respective set of one or more settings based on a determination of which type of computer system is the computer system. In some embodiments, in response to receiving the respective set of one or more settings, the first computer system configured itself differently according to different settings of the respective set one or more settings based on a determination of which type of computer system is the computer system.

In some embodiments, in response to detecting the input corresponding to the user interface element to apply the respective set of one or more settings to the first computer system, the first computer system displays, via the one or more display generation components, an indication (e.g., 622 and/or 618e) (e.g., an icon, a widget, a user interface element, and/or a background color) that the respective set of one or more settings are currently being used by the first computer system. In some embodiments, the indication is displayed at a location within the user interface. In some embodiments, the indication is displayed outside of the user interface. In some embodiments, the indication is displayed on top of the user interface.

In some embodiments, the first computer system detects, via the one or more input devices, a set of one or more inputs, wherein the set of one or more input includes an input (e.g., 605g1 and/or 605g2) (e.g., a tap input and/or a voice request to revert back to the first set of one or more settings) corresponding to the indication that the respective set of one or more settings are currently being used by the first computer system. In some embodiments, the set of one or more inputs includes an input corresponding to a user interface element to confirm to return to the first set of one or more settings. In some embodiments, in response to detecting the set of one or more inputs, the first computer system displays, via the one or more display generation components, the user interface (or another user interface different from the user interface) according to the first set of one or more settings. In some embodiments, displaying the user interface according to the first set of one or more settings includes displaying the user interface with another appearance different from the first appearance and/or the second appearance.

In some embodiments, while displaying the indication that the respective set of one or more settings are currently being used by the first computer system, the first computer system detects, via the one or more input devices, an input (e.g., 605g1 and/or 605g2) (e.g., a tap input and/or a voice request to revert back to the first set of one or more settings) corresponding to the indication that the respective set of one or more settings are currently being used by the first computer system. In some embodiments, in response to detecting the input corresponding to the indication that the respective set of one or more settings are currently being used by the first computer system, the first computer system displays, via the one or more display generation components, a user interface element (e.g., 634) to return to the first set of one or more settings. In some embodiments, while displaying the user interface element to return to the first set of one or more settings, the first computer system detects, via the one or more input devices, an input (e.g., 605h) (e.g., a tap input and/or a voice request to revert back to the first set of one or more settings) corresponding to the user interface element to return to the first set of one or more settings. In some embodiments, in response to detecting the input corresponding to the user interface element to return to the first set of one or more settings, the first computer system displays, via the one or more display generation components, the user interface (or another user interface different from the user interface) according to the first set of one or more settings. In some embodiments, displaying the user interface according to the first set of one or more settings includes displaying the user interface with another appearance different from the first appearance and/or the second appearance.

In some embodiments, while displaying the indication that the respective set of one or more settings are currently being used by the first computer system, the first computer system detects, via the one or more input devices, an input (e.g., 605f) (e.g., a tap input on an icon of an application and/or a voice request to initiate an application) corresponding to a request to display another user interface, wherein the other user interface is different from the user interface. In some embodiments, the user interface is from a first application. In some embodiments, the other user interface is from another application different from the application. In some embodiments, the other user interface is from an operating system of the computer system. In some embodiments, in response to detecting the input corresponding to the request to display the other user interface (and/or while the first computer system continues to operate according to the respective set of one or more settings), the first computer system displays, via the one or more display generation components, the other user interface (e.g., 608). In some embodiments, in response to detecting the input corresponding to the request to display the other user interface, the computer system ceases display of the user interface. In some embodiments, in response to detecting the input corresponding to the request to display the other user interface, the first computer system maintains display of, via the one or more display generation components, the indication that the respective set of one or more settings are currently being used by the first computer system.

In some embodiments, the user interface is a first user interface. In some embodiments, after displaying, via the one or more display generation components, a second user interface (e.g., lock user interface, such as described above with respect to FIG. 6H) according to the respective set of one or more settings, in accordance with a determination that the computer system has been locked since displaying the second user interface according to the respective set of one or more settings, the first computer system displays, via the one or more display generation components, a third user interface (e.g., such as described above with respect to FIG. 6H) according to the first set of one or more settings (e.g., and not according to the respective set of one or more settings). In some embodiments, the second user interface is the first user interface. In some embodiments, the second user interface is different from the first user interface. In some embodiments, the third user interface is different from the second user interface and/or the first user interface. In some embodiments, after displaying, via the one or more display generation components, the second user interface according to the respective set of one or more settings, in accordance with a determination that the computer system has not been locked since displaying the second user interface according to the respective set of one or more settings, the first computer system displays, via the one or more display generation components, the third user interface according to the respective set of one or more settings (e.g., and not according to the first set of one or more settings). In some embodiments, while displaying the second user interface according to the respective set of one or more settings, the computer system detects a request to lock the computer system. In some embodiments, detecting the request to lock the computer system includes detecting, via the one or more input devices, an input (e.g., a tap input and/or a voice request to lock the computer system) corresponding to a request to lock the computer system. In some embodiments, detecting the request to lock the computer system includes detecting that the computer system has not been interacted with for a predefined period of time (e.g., 30 seconds to 5 minutes). In some embodiments, detecting the request to lock the computer system includes receiving, from another computer system different from the computer system, a request to lock the computer system. In some embodiments, in response to detecting the request to lock the computer system, the computer system (1) locks the computer system and (2) configured to the computer system to operate according to the first set of one or more settings instead of the respective set of one or more settings.

In some embodiments, the user interface is a first user interface. In some embodiments, while displaying, via the one or more display generation components, a second user interface according to the respective set of one or more settings, the first computer system detects that the second computer system is no longer in proximity with (e.g., in communication with, such as via a wireless communication channel as described above, and/or within a predefined distance, such as 5-10 feet, of) the computer system (e.g., such as described above with respect to FIG. 6H). In some embodiments, the second user interface is the first user interface. In some embodiments, the second user interface is different from the first user interface. In some embodiments, the third user interface is different from the second user interface and/or the first user interface. In some embodiments, while displaying the second user interface according to the respective set of one or more settings, the computer system detects that the second computer system is still in proximity with (e.g., in communication with, such as via a wireless communication channel as described above, and/or within the predefined distance, such as 5-10 feet, of) the computer system. In some embodiments, in response to detecting that the second computer system is still in proximity with the first computer system, the computer system maintains display of the second user interface according to the respective set of one or more settings. In some embodiments, in response to detecting that the second computer system is no longer in proximity with the first computer system, the first computer system displays, via the one or more display generation components, the second user interface according to the first set of one or more settings. In some embodiments, displaying the second user interface according to the respective set of one or more settings includes displaying the second user interface with a third appearance. In some embodiments, displaying the second user interface according to the first set of one or more settings includes displaying the second user interface with a fourth appearance different from the third appearance.

In some embodiments, the respective set of one or more settings includes at least one setting (e.g., light mode, low power mode, text size, and/or color mode) that is the same as (e.g., as the same value as) (e.g., such as described above with respect to FIG. 6F) a setting included in the first set of one or more settings.

In some embodiments, the user interface is displayed with a third appearance (e.g., a set of one or more visual characteristics, such as color, shape, size, location, text size, and/or text font) when displayed according to the first set of one or more settings. In some embodiments, while displaying the user interface according to the first set of one or more settings, the first computer system receives, from a third computer system different from the first computer system and the second computer system, a second set of one or more settings (e.g., display settings, audio settings, haptic settings, output settings, and/or accessibility settings) (e.g., such as described above with respect to FIG. 6I) (and/or an indication of the second set of one or more settings). In some embodiments, the third computer system is a phone, a watch, a tablet, a fitness tracking device, a wearable device, an accessory, a speaker, a light, a head-mounted display (HMD), and/or a personal computing device. In some embodiments, in response to receiving the second set of one or more settings, the first computer system displays, via the one or more display generation components, a user interface element (e.g., a virtual button, an icon, a widget, a control, and/or a window) to apply the second set of one or more settings to the first computer system (e.g., such as described above with respect to FIG. 6I). In some embodiments, the user interface element is displayed with and/or on top of the user interface. In some embodiments, while displaying the user interface element to apply the second set of one or more settings to the first computer system, the first computer system detects, via the one or more input devices, an input (e.g., a tap input, a voice input, and/or an air gesture) (e.g., such as described above with respect to FIG. 6I) corresponding to (e.g., directed to, at a location of, related to, and/or associated with) the user interface element to apply the second set of one or more settings to the first computer system. In some embodiments, the tap input is on the user interface element to apply the second set of one or more settings to the first computer system. In some embodiments, the voice input includes a request corresponding to the user interface element to apply the second set of one or more settings to the first computer system (e.g., “Select yes,” and/or “Apply those settings,”). In some embodiments, the air gesture includes a gesture corresponding to a request to select the user interface element to apply the second set of one or more settings to the first computer system (e.g., a pinch and/or swipe). In some embodiments, in response to detecting the input corresponding to the user interface element to apply the second set of one or more settings to the first computer system, the first computer system displays, via the one or more display generation components, the user interface with a fourth appearance (e.g., a set of one or more visual characteristics, such as color, shape, size, location, text size, and/or text font) (e.g., such as described above with respect to FIG. 6I) different from the first appearance, the second appearance, and the third appearance.

Note that details of the processes described above with respect to process 700 (e.g., FIG. 7) are also applicable in an analogous manner to other processes described herein. For example, process 900 optionally includes one or more of the characteristics of the various processes described above with reference to process 700. For example, after detecting the input to apply the respective set of one or more settings of process 700 the computer system can detect the input corresponding to the zoom of the respective portion of the virtual environment of process 900. For brevity, these details are not repeated herein.

FIGS. 8A-8G illustrate exemplary techniques for zooming content in accordance with some embodiments. The user interfaces in these figures are used to illustrate the processes described below, including the processes in FIG. 9.

FIGS. 8A-8G illustrate environment 800. Environment 800 includes a physical element and virtual elements. The virtual elements in environment 800 are user interface elements displayed by a computer system. The physical element is an object that is physically present within a real-world environment. In the example of FIGS. 8A-8G, the computer system is a head-mounted display device that a subject is wearing. It should be recognized that the computer system can be other types of computer systems such as a tablet, a smart watch, a laptop, a communal device, a smart speaker, an accessory, a personal gaming system, a desktop computer, a fitness tracking device, and/or a smart phone. In some embodiments, the computer system includes and/or is in communication with one or more input devices (e.g., a sensor, a camera, a lidar detector, a motion sensor, an infrared sensor, a touch-sensitive surface, a physical input mechanism, and/or a microphone). In some embodiments, the computer system includes and/or is in communication with one or more output devices (e.g., a display screen, a projector, a touch-sensitive display, a speaker, and/or a movement component). In some embodiments, the computer system includes one or more components and/or features described above in relation to portable multifunction device 100, device 300, or device 500.

Throughout FIGS. 8A-8G, the computer system detects (e.g., via one or more cameras and/or sensors) sensor data, communicates the sensor data, detects an air gesture using the sensor data, communicates an identification of the air gesture, determines an operation to perform in response to the air gesture, and/or causes an operation to be performed. Causing operations to be performed includes the computer system altering the display of elements within environment 800, as will be discussed below.

Throughout FIGS. 8A-8G, the computer system displays virtual user interface elements including messages window 806, controller window 808, and zoom window 814. At FIGS. 8A-8G, the computer system does not move the virtual user interface elements to follow movements of the computer system and/or changes in the user's (e.g., David's) gaze. For example, as David's gaze looks right and his head looks right, messages window 806 moves left to maintain a previous position in environment 800. In some embodiments, the computer system moves the virtual user interface elements as the computer system moves and/or as David adjusts his gaze. For example, if David moves his head to the left and/or looks left, the computer system moves messages window 806 to the left to maintain a relative position to David's view.

FIG. 8A illustrates environment 800 including book 804, messages window 806, and controller window 808. Throughout FIGS. 8A-8G, book 804 is a physical element that is a real object that David can touch and see without wearing the computer system.

As illustrated in FIG. 8A, the computer system displays the virtual element messages window 806 in a zero amount of zoom. Without wearing computer system 802, David cannot see messages window 806. Messages window 806 is a virtual representation of David's text messages. For example, messages window 806 includes previews of messages between David and Sarah, Jack, and Mom. Messages window 806 also includes view 806a, which is a view of a messaging session between David and Sarah. View 806a includes contact indicator 806b (e.g., “S”), which indicates that view 806a includes messages corresponding to Sarah. View 806a also includes message 806c from David (e.g., “Good Morning!”) and message control 806d with which David can begin composing a new message.

As illustrated in FIG. 8A, the computer system displays controller window 808 in the zero amount of zoom. Similarly to messages window 806, without wearing computer system 802, David cannot see controller window 808. Controller window 808 is a virtual representation of settings controls related to zoom functions. In some embodiments, the computer system displays controller window 808 in response to detecting a series of inputs navigating through a settings application. Controller window 808 includes full screen control 808a and window control 808b. Window control 808b is a control with which the computer system displays a window that zooms in on physical and virtual elements captured by the computer system.

At FIG. 8A, while displaying controller window 808, the computer system detects input 805a. Input 805a is illustrated as an air gesture input from hand representation 810 toward window control 808b. FIG. 8A illustrates hand representation 810 to further indicate that David is performing input 805a by pointing to window control 808b. It should be recognized that one or more other input types can be used. For example, while displaying controller window 808, the computer system can detect a gaze input directed to window control 808b. For another example, while displaying controller window 808, the computer system can detect a pinch input from hand representation 810 toward window control 808b.

As illustrated in FIG. 8B, in response to detecting input 805a, the computer system displays zoom region 812 in environment 800. At FIG. 8B, zoom region 812 is a virtual element that the computer system displays to zoom in on portions of virtual and/or physical elements within environment 800 that are captured within zoom region 812 based on which of the controls of zoom window 814 (e.g., described below) are selected. Unlike other user interface elements displayed by the computer system, the computer system moves zoom region 812 around environment 800 according to David's gaze. For example, if the computer system detects David looking up, the computer system moves zoom region 812 up to follow David's gaze. In some embodiments, the computer system moves zoom region 812 as the computer system moves. For example, if David moves his head back and forth (e.g., as opposed to just his gaze), the computer system moves zoom region 812 back and forth. In some embodiments, the computer system does not move zoom region 812 to follow David's gaze. For example, as David's gaze moves, zoom region 812 remains stationary relative to David's movement in the environment. In embodiments where the computer system does not move zoom region 812 to follow David's gaze, inputs directly to zoom region 812 can move zoom region 812. For example, in response to detecting a grab input on zoom region 812, the computer system moves zoom region 812 to the corresponding location where the grab input is released. As illustrated in FIG. 8B, the computer system displays zoom region 812 in the direction that David is looking, which is in an area of environment 800 where no elements (e.g., physical or virtual) are present.

Also illustrated in FIG. 8B, in response to detecting input 805a, the computer system ceases display of controller window 808 and displays zoom window 814. At FIG. 8B, zoom window 814 includes controls with which the computer system controls elements that zoom region 812 zooms in on. For example, depending on selected settings, the computer system controls zoom region to zoom in on virtual elements and not physical elements (e.g., corresponding to applications control 814a), physical elements and not virtual elements (e.g., corresponding to surroundings control 814b), or both physical and virtual elements (e.g., corresponding to applications and surroundings control 814c). As illustrated in FIG. 8B, the computer system displays zoom window 814 with no controls selected (e.g., neither applications control 814a nor surroundings control 814b) and therefore zoom window 814 does not zoom virtual elements or physical elements.

At FIG. 8B, while displaying zoom window 814, the computer system detects input 805b. Input 805b is illustrated as an air gesture input from hand 810 representation toward surroundings control 814b. FIG. 8B illustrates hand representation 810 to further indicate that David is performing input 805b by pointing to surroundings control 814b. It should be recognized that one or more other input types can be used. For example, while displaying zoom window 814, the computer system can detect a gaze input directed to surroundings control 814b. For another example, while displaying zoom window 814, the computer system can detect a pinch input from hand representation 810 toward surroundings control 814b.

As illustrated in FIG. 8C, in response to detecting input 805b, the computer system selects surroundings control 814b, as indicated by the computer system displaying surroundings control 814b as emphasized. In some embodiments, the computer system displays surroundings control 814b as selected in a different manner, such as displaying a check mark indicator next to or within surroundings control 814b. At a time between FIGS. 8B and 8C, David directs his gaze downward toward book 804. As discussed above, the computer system moves zoom region 812 to follow David's gaze. As such, in response to detecting David directing his gaze downward toward book 804, the computer system displays zoom region 812 as hovering over book 804. As surroundings control 814b is selected, zoom region 812 is configured to zoom in on physical elements and therefore zooms in on the part of book 804 that zoom region 812 is hovering over. Specifically, the computer system displays zoom region 812 as zooming in on (e.g., enlarging and/or emphasizing) portions of the text included in book 804 as well as the inner spine of book 804.

At a time between FIGS. 8C and 8D, the computer system detects David moving his gaze up and to the left. As illustrated in FIG. 8D, in response to detecting David move his gaze, the computer system displays zoom region 812 as partially hovering over messages window 806 and book 804. However, as surroundings control 814b is selected, zoom region 812 is not configured to zoom in on virtual elements. Therefore, the computer system displays zoom region 812 as zooming in on portions of the text included in book 804 as well as a top edge of book 804 but not zooming in on the portions of messages window 806 over which zoom region 812 is hovering. For example, the computer system displays message control 806d and a part of the bottom border of messages window 806 within zoom region 812 but does not display zoom region 812 as zooming in on message control 806d or the bottom border of messages window 806.

At FIG. 8D, while displaying zoom window 814, the computer system detects input 805d. Input 805d is illustrated as an air gesture input from hand representation 810 toward applications control 814a. FIG. 8D illustrates hand representation 810 to further indicate that David is performing input 805d by pointing to applications control 814a. It should be recognized that one or more other input types can be used. For example, while displaying zoom window 814, the computer system can detect a gaze input directed to applications control 814a. For another example, while displaying zoom window 814, the computer system can detect a pinch input from hand representation 810 toward applications control 814a.

As illustrated in FIG. 8E, in response to detecting input 805d, the computer system selects applications control 814a, as indicated by the computer system displaying applications control 814a as emphasized. In some embodiments, the computer system displays applications control 814a as selected in a different manner, such as displaying a check mark indicator next to or within applications control 814a. At a time between FIGS. 8D and 8E, David directs his gaze upward toward messages window 806. As discussed above, the computer system moves zoom region 812 to follow David's gaze. As such, in response to detecting David directing his gaze upward toward messages window 806, the computer system displays zoom region 812 as hovering over messages window 806. As applications control 814a is selected, zoom region 812 is configured to zoom in on virtual elements and therefore zooms in on the part of messages window 806 that zoom region 812 is hovering over. Specifically, the computer system displays zoom region 812 as zooming in on (e.g., enlarging and/or emphasizing) portions of the list of message conversations and a portion of message 806c.

At a time between FIGS. 8E and 8F, the computer system detects David moving his gaze down and to the right. In response to detecting David move his gaze, the computer system displays zoom region 812 as partially hovering over messages window 806 and book 804. However, as applications control 814a is selected, zoom region 812 is not configured to zoom in on physical elements. Therefore, the computer system displays zoom region 812 as zooming in on a portion of message control 806d and a bottom border of messages window 806 but not zooming in on the portions of text of book 804 over which zoom region 812 is hovering. For example, the computer system displays portions of text within book 804 and the top edge of book 804 within zoom region 812 but does not display zoom region 812 as zooming in on the portions of text within book 804 or the top edge of book 804.

At FIG. 8F, while displaying zoom window 814, the computer system detects input 805f. Input 805f is illustrated as an air gesture input from hand representation 810 toward applications and surroundings control 814c. FIG. 8F illustrates hand representation 810 to further indicate that David is performing input 805f by pointing to applications and surroundings control 814c. It should be recognized that one or more other input types can be used. For example, while displaying zoom window 814, the computer system can detect a gaze input directed to applications and surroundings control 814c. For another example, while displaying zoom window 814, the computer system can detect a pinch input from hand representation 810 toward applications and surroundings control 814c.

As illustrated in FIG. 8G, in response to detecting input 805f, the computer system selects applications and surroundings control 814c, as indicated by the computer system displaying applications and surroundings control 814c as emphasized. In some embodiments, the computer system displays applications and surroundings control 814c as selected in a different manner, such as displaying a check mark indicator next to or within applications and surroundings control 814c. Between FIGS. 8F and 8G, David does not alter his gaze. As such, the computer system continues to display zoom region 812 as hovering over messages window 806 and book 804. As applications and surroundings control 814c is selected, zoom region 812 is configured to zoom in on both virtual and physical elements and therefore zooms in on the part of messages window 806 that zoom region 812 is hovering over as well as the part of book 804 that zoom region 812 is hovering over. Specifically, the computer system displays zoom region 812 as zooming in on (e.g., enlarging and/or emphasizing) (1) a portion of message control 806d and a part of the bottom border of messages window 806 within zoom region 812 and (2) portions of text within book 804 and the top edge of book 804 within zoom region 812.

Although the above describes computer system 600 zooming messages window 806 and book 804 as David looks in their corresponding direction while computer system 600 displays zoom region 812, in some embodiments, in response to detecting an input (e.g., air gesture input or gaze input) directed to full screen control 808a at FIG. 8A, the computer system zooms in David's entire view of environment 800. For example, at FIG. 8A, in response to David selecting full screen zoom control 808a, the computer system zooms in David's entire view of environment 800. For example, the computer system will zoom the elements that David selects that are displayed by the computer system.

FIG. 9 is a flow diagram illustrating a process (e.g., process 900) for zooming content in accordance with some embodiments. Some operations in process 900 are, optionally, combined, the orders of some operations are, optionally, changed, and some operations are, optionally, omitted.

As described below, process 900 provides an intuitive way for zooming content in accordance with some embodiments. Process 900 reduces the cognitive burden on a user, thereby creating a more efficient human-machine interface. For battery-operated computing devices, enabling a user to interact with such devices faster and more efficiently conserves power and increases the time between battery charges. Providing improved feedback (such as by changing a zoom of different objects depending on different settings as directed by a user and displaying a virtual environment in a user interface element that is locked in a position of an environment as the computer system changes pose) enhances the operability of the device by reducing accidental and mistaken inputs, reducing energy usage by the device. Providing additional control options in response to detecting an input without cluttering the UI with additional displayed controls (such as by changing a zoom for virtual and physical objects depending on current settings) enhances the operability of the device by reducing unnecessary inputs and/or steps to navigates through different user interfaces or sets of controls reducing energy usage by the device. Performing an operation when a set of conditions has been met without requiring further user input (such as by changing a zoom for virtual and physical objects depending on current settings) enhances the operability of the device by reducing unnecessary inputs and/or steps to navigate through different user interfaces or sets of controls, reducing energy usage by the device. Reducing the number of inputs needed to perform an operation (such as by changing a zoom for virtual and physical objects depending on current settings, displaying a virtual environment in a user interface element that changes position as the computer system changes pose) enhances the operability of the device by reducing the number of inputs and time required to perform a particular operation, reducing energy usage by the device. Providing improved feedback (such as by changing a zoom of particular objects after both objects were zoomed) enhances the operability of the device by reducing accidental and mistaken inputs, reducing energy usage by the device.

In some embodiments, process 900 is performed at a first computer system (e.g., the computer system as described above with respect to FIGS. 8A-8G) that is in communication (e.g., wired communication and/or wireless communication) with (and/or includes) one or more display generation components (e.g., a display screen, a projector, a head mounted display, and/or a touch-sensitive display) and one or more input devices (e.g., a camera, a depth sensor, a microphone, a hardware input mechanism, a rotatable input mechanism, a heart monitor, a temperature sensor, and/or a touch-sensitive surface). In some embodiments, the first computer system is a phone, a watch, a tablet, a fitness tracking device, a wearable device, an accessory, a speaker, a light, a head-mounted display (HMD), and/or a personal computing device.

The first computer system displays (902), via the one or more display generation components, a virtual environment (e.g., 800) including a user interface element (e.g., 806) (e.g., user interface object, a virtual button, an icon, a widget, a control, and/or a window) at a first zoom level (e.g., such as described above with respect to FIG. 8A) (e.g., magnification and/or scale) and a representation of a camera feed (e.g., such as described above with respect to FIG. 8A) at a second zoom level (e.g., magnification and/or scale). In some embodiments, the camera feed is a live view. In some embodiments, the camera feed is detected by and/or received from a camera of the computer system. In some embodiments, the camera is a camera of the one or more input devices. In some embodiments, the first zoom level is different from the second zoom level. In some embodiments, the first zoom level is the same as the second zoom level. In some embodiments, the first zoom level and/or the second zoom level is a zero zoom level (e.g., no zoom and/or default size).

While (and/or after) displaying the virtual environment including the user interface element at the first zoom level and the representation of the camera feed at the second zoom level, the first computer system detects (904), via the one or more input devices, an input (e.g., a tap input, a voice input, and/or an air gesture) (e.g., 805b, 805d, and/or 805f) corresponding to a zoom of a respective portion of the virtual environment. In some embodiments, the tap input is on a user interface element (e.g., user interface object, a virtual button, an icon, a widget, a control, and/or a window) to zoom the respective portion of the virtual environment. In some embodiments, the voice input includes a request to zoom the respective portion of the virtual environment (e.g., “Zoom the environment” and/or “Zoom the menu”). In some embodiments, the air gesture includes a gesture corresponding to a request to zoom the respective portion of the virtual environment (e.g., a swipe down or pinch with rotation).

In response to detecting the input corresponding to the zoom of the respective portion of the virtual environment and in accordance with a determination that the respective portion of the virtual environment corresponds to virtual elements (e.g., virtual objects that are rendered and placed within the representation of the camera feed) and physical elements (e.g., physical objects that are included in the representation of the camera feed), the first computer system displays (906), via the one or more display generation components, the virtual environment including the user interface element at a third zoom level (e.g., such as described above with respect to FIG. 8F) (e.g., magnification and/or scale) and the representation of the camera feed at a fourth zoom level (e.g., magnification and/or scale) (e.g., such as described above with respect to FIG. 8F), wherein the third zoom level is different from the first zoom level, and wherein the fourth zoom level is different from the second zoom level;. In some embodiments, the third zoom level is different from the second zoom level and/or the fourth zoom level. In some embodiments, the fourth zoom level is different from the first zoom level and/or the third zoom level. In some embodiments, the third zoom level is the same as the second zoom level and/or the fourth zoom level. In some embodiments, the fourth zoom level is the same as the first zoom level and/or the third zoom level.

In some embodiments, in response to detecting the input corresponding to the zoom of the respective portion of the virtual environment and in accordance with a determination that the respective portion of the virtual environment corresponds to virtual elements and not physical elements, the first computer system displays, via the one or more display generation components, the virtual environment including the user interface element at the third zoom level and the representation of the camera feed at the second zoom level (e.g., such as described above with respect to FIGS. 8E-8F).

In some embodiments, in response to detecting the input corresponding to the zoom of the respective portion of the virtual environment and in accordance with a determination that the respective portion of the virtual environment corresponds to physical elements and not virtual elements, the first computer system displays, via the one or more display generation components, the virtual environment including the user interface element at the first zoom level and the representation of the camera feed at the fourth zoom level (e.g., such as described above with respect to FIGS. 8C-8D).

In some embodiments, in response to detecting the input corresponding to the zoom of the respective portion of the virtual environment and in accordance with a determination that the respective portion of the virtual environment does not correspond to physical elements and does not correspond to virtual elements, the first computer system displays, via the one or more display generation components, the virtual environment including the user interface element without being zoomed (e.g., at the first zoom level or another zoom level different from the first zoom level) and the representation of the camera feed without being zoomed (e.g., at the second zoom level or another zoom level different from the second zoom level) (e.g., such as described above with respect to FIG. 8B).

In some embodiments, the first zoom level is a zero zoom level (e.g., such as described above with respect to FIGS. 8A-8B) (e.g., unzoomed, without zoom, no zoom, and/or default size). In some embodiments, the second zoom level is a zero zoom level (e.g., unzoomed, without zoom, no zoom, and/or default size).

In some embodiments, the user interface element is a first user interface element. In some embodiments, the first user interface element at the third zoom level and the representation of the camera feed at the fourth zoom level are included in a second user interface element (e.g., 812) (e.g., a virtual button, an icon, a widget, a control, and/or a window). In some embodiments, the virtual environment is displayed within the second user interface element. In some embodiments, a portion of the virtual environment is displayed outside of the second user interface element. In some embodiments, the second portion of the virtual environment displayed outside of the second user interface element includes one or more user interface elements (e.g., user interface object, a virtual button, an icon, a widget, a control, and/or a window) and/or a representation of the camera feed, such as a wider and/or extended view of the camera feed than included in the second user interface element. In some embodiments, the portion of the virtual environment displayed outside of the second user interface element is not zoomed in or out (e.g., unzoomed, without zoom, no zoom, and/or default size). In some embodiments, the first user interface element at the first zoom level and the representation of the camera feed at the second zoom level are included in the second user interface element. In some embodiments, the first user interface element at the first zoom level and the representation of the camera feed at the second zoom level are not included in the second user interface element. In some embodiments, the second user interface element is different (and/or separate) from the first user interface element.

In some embodiments, the second user interface element is at a first position (e.g., location, orientation, and/or coordinate) in the virtual environment while the computer system is in (and/or at) a first position (e.g., pose, orientation, and/or location) in a physical environment. In some embodiments, while the second user interface element, the first computer system includes the first user interface element at the third zoom level and the representation of the camera feed at the fourth zoom level, is at the first position in the virtual environment, detecting, via the one or more input devices, that the computer system is in a second position (e.g., pose, orientation, and/or location) in the physical environment, wherein the second position in the physical environment is different from the first position in the physical environment. In some embodiments, in response to detecting that the computer system is in the second position in the physical environment, the first computer system updates (e.g., changes, maintains, ceases, forgoes, and/or modifies) display of, via the one or more display generation components, the second user interface element (and/or the virtual representation, the first user interface element, and/or the representation of the camera feed such that the representation of the camera feed at the fourth zoom level is updated to reflect that the computer system is in the second position in the physical environment) while maintaining the second user interface element at the first position in the virtual environment (e.g., locked in place, such as described above with respect to FIG. 8B). In some embodiments, changing display of the second user interface element includes changing a perspective of the second user interface element. In some embodiments, changing display of the second user interface element includes ceasing or forgoing display of the second user interface element. In some embodiments, the representation of the camera feed changes perspective in response to one or more cameras capturing the camera feed being repositioned.

In some embodiments, the virtual environment, including the first user interface element at the third zoom level and the representation of the camera feed at the fourth zoom level, is displayed with a first appearance while the computer system is in (and/or at) a first position (e.g., pose, orientation, and/or location) in a physical environment. In some embodiments, while displaying the virtual environment with the first appearance, the first computer system detects, via the one or more input devices, that the computer system is in a second position (e.g., pose, orientation, and/or location) in the physical environment, wherein the second position in the physical environment is different from the first position in the physical environment. In some embodiments, in response to detecting that the computer system is in the second position in the physical environment, the first computer system displays, via the one or more display generation components, the virtual environment with a second appearance different from the first appearance (e.g., moves with the subject, such as described above with respect to FIG. 8B). In some embodiments, displaying the virtual environment with the first appearance includes displaying, via the one or more display generation components, the first user interface element, at the third zoom level, at a particular position. In some embodiments, displaying the virtual environment with the second appearance includes displaying, via the one or more display generation components, the first user interface element, at the third zoom level, at another position different from the particular position. In some embodiments, in response to detecting that the computer system is in the second position in the physical environment, the computer system ceases display of the first user interface element. In some embodiments, displaying the virtual environment with the first appearance includes displaying, via the one or more display generation components, the representation of the camera feed, at the fourth zoom level, with an appearance corresponding to the first position in the physical environment. In some embodiments, displaying the virtual environment with the second appearance includes displaying, via the one or more display generation components, the representation of the camera feed, at the fourth zoom level, with an appearance corresponding to the second position in the physical environment. In some embodiments, the appearance corresponding to the second position in the physical environment is different from the appearance corresponding to the first position in the physical environment.

In some embodiments, the one or more display generation components are configured to display content up to a maximum display area. In some embodiments, display of the virtual environment, including the user interface element at the first zoom level and the representation of the camera feed at the second zoom level, covers all of the maximum display area (e.g., such as described above with respect to FIG. 8G). In some embodiments, while displaying the representation of the camera feed at the second zoom level, the computer system does not display any representation of the camera feed at another zoom level different from the second zoom level. In some embodiments, display of the virtual environment, including the user interface element at the third zoom level and the representation of the camera feed at the fourth zoom level, covers all of the maximum display area. In some embodiments, while displaying the representation of the camera feed at the fourth zoom level, the computer system does not display any representation of the camera feed at another zoom level different from the second zoom level.

In some embodiments, the one or more display generation components are configured to display content up to a maximum display area. In some embodiments, the representation of the camera feed at the fourth zoom level is displayed in a first portion of the maximum display area but not in a second portion of the maximum display area. In some embodiments, the second portion of the maximum display area is different (and/or separate) from the first portion of the maximum display area (e.g., such as described above with respect to FIG. 8A).

In some embodiments, the one or more display generation components are configured to display content up to a maximum display area. In some embodiments, the representation of the camera feed at the fourth zoom level is displayed to cover all of the maximum display area (e.g., such as described above with respect to FIG. 8G). In some embodiments, the user interface element is displayed within the representation of the camera feed.

In some embodiments, the respective portion of the virtual environment is a first respective portion of the virtual environment. In some embodiments, while displaying the virtual environment including the user interface element at the third zoom level and the representation of the camera feed at the fourth zoom level, the first computer system detects, via the one or more input devices, an input (e.g., zoom again, such as described above with respect to FIG. 8G) (e.g., a tap input, a voice input, and/or an air gesture) corresponding to a zoom of a second respective portion of the virtual environment. In some embodiments, the tap input is on a user interface element (e.g., user interface object, a virtual button, an icon, a widget, a control, and/or a window) to zoom the second respective portion of the virtual environment. In some embodiments, the voice input includes a request to zoom the second respective portion of the virtual environment (e.g., “Zoom the environment” and/or “Zoom the menu”). In some embodiments, the air gesture includes a gesture corresponding to a request to zoom the second respective portion of the virtual environment (e.g., a swipe down or pinch with rotation). In some embodiments, in response to detecting the input corresponding to the zoom of the second respective portion of the virtual environment, in accordance with a determination that the second respective portion of the virtual environment corresponds to virtual elements (e.g., virtual objects that are rendered and placed within the representation of the camera feed) and not physical elements (e.g., physical objects that are included in the representation of the camera feed), the first computer system displays, via the one or more display generation components, the virtual environment including the user interface element at the third zoom level (e.g., magnification and/or scale) and the representation of the camera feed at the second zoom level. In some embodiments, in response to detecting the input corresponding to the zoom of the second respective portion of the virtual environment, in accordance with a determination that the second respective portion of the virtual environment corresponds to physical elements (e.g., physical objects that are included in the representation of the camera feed) and not virtual elements (e.g., virtual objects that are rendered and placed within the representation of the camera feed), the first computer system displays, via the one or more display generation components, the virtual environment including the user interface element at the first zoom level and the representation of the camera feed at fourth eighth zoom level.

In some embodiments, the user interface element is at a first position (e.g., location, orientation, and/or coordinate) in the virtual environment while the computer system is in (and/or at) a first position (e.g., pose, orientation, and/or location) in a physical environment. In some embodiments, while displaying the user interface element at the first position, the first computer system detects, via the one or more input devices, that the computer system is in a second position (e.g., pose, orientation, and/or location) in the physical environment, wherein the second position in the physical environment is different from the first position in the physical environment. In some embodiments, in response to detecting that the computer system is in the second position in the physical environment, the first computer system updates (e.g., changes, maintains, ceases, forgoes, and/or modifies) display of, via the one or more display generation components, the user interface element (and/or the virtual representation and/or the representation of the camera feed such that the representation of the camera feed at the fourth zoom level is updated to reflect that the computer system is in the second position in the physical environment) while maintaining the user interface element at the first position in the virtual environment (e.g., such as described above with respect to FIG. 8A). In some embodiments, changing display of the user interface element includes changing a perspective of the user interface element. In some embodiments, changing display of the user interface element includes ceasing or forgoing display of the user interface element. In some embodiments, the representation of the camera feed changes perspective in response to one or more cameras capturing the camera feed being repositioned.

In some embodiments, the user interface element is at a first position (e.g., location, orientation, and/or coordinate) in the virtual environment while the computer system is in (and/or at) a first position (e.g., pose, orientation, and/or location) in a physical environment. In some embodiments, while displaying the user interface element at the first position, the first computer system detects, via the one or more input devices, that the computer system is in a second position (e.g., pose, orientation, and/or location) in the physical environment, wherein the second position in the physical environment is different from the first position in the physical environment. In some embodiments, in response to detecting that the computer system is in the second position in the physical environment, the first computer system maintains display of, via the one or more display generation components, the user interface element (e.g., while changing display of the virtual representation and/or the representation of the camera feed such that the representation of the camera feed at the fourth zoom level is updated to reflect that the computer system is in the second position in the physical environment) (e.g., such as described above with respect to FIG. 8A). In some embodiments, the user interface element is maintained as a result of the user interface element moving from the first position in the virtual environment to a second position in the virtual environment different from the first position in the virtual environment. In some embodiments, in response to detecting that the computer system is in the second position in the physical environment, the computer system moves the user interface element to a second position in the virtual environment, different from the first position in the virtual environment, such that the user interface element does not appear to be moved relative to a viewing angle of the virtual environment. In some embodiments, the representation of the camera feed changes perspective in response to one or more cameras capturing the camera feed being repositioned.

In some embodiments, the third zoom level is a larger magnification (e.g., zoom and/or enlargement) than the first zoom level. In some embodiments, the fourth zoom level is a larger magnification than the second zoom level (e.g., such as described above with respect to FIG. 8A).

Note that details of the processes described above with respect to process 900 (e.g., FIG. 9) are also applicable in an analogous manner to the processes described herein. For example, process 700 optionally includes one or more of the characteristics of the various processes described herein with reference to process 900. For example, the zoom of virtual and physical objects of process 900 can be a first set of one or more settings displayed of process 700. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve managing settings. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for managing settings. Accordingly, use of such personal information data enables users to have a computer system perform operations for managing settings. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a first computer system that is in communication with one or more display generation components and one or more input devices:
displaying, via the one or more display generation components, a user interface according to a first set of one or more settings;
while displaying the user interface according to the first set of one or more settings, receiving, from a second computer system different from the first computer system, a respective set of one or more settings;
in response to receiving the respective set of one or more settings, displaying, via the one or more display generation components, a user interface element to apply the respective set of one or more settings to the first computer system;
while displaying the user interface element to apply the respective set of one or more settings to the first computer system, detecting, via the one or more input devices, an input corresponding to the user interface element to apply the respective set of one or more settings to the first computer system; and
in response to detecting the input corresponding to the user interface element to apply the respective set of one or more settings to the first computer system:
in accordance with a determination that the respective set of one or more settings includes a first setting, displaying, via the one or more display generation components, the user interface with a first appearance according to the first setting; and
in accordance with a determination that the respective set of one or more settings includes a second setting, displaying, via the one or more display generation components, the user interface with a second appearance according to the second setting, wherein the second setting is different from the first setting, and wherein the second appearance is different from the first appearance.

2. The method of claim 1, wherein the respective set of one or more settings is received in conjunction with the first computer system being within proximity of the second computer system.

3. The method of claim 1, wherein:
the first set of one or more settings includes a third setting corresponding to an appearance of the user interface while displaying the user interface according to the first set of one or more settings;
the first setting corresponds to the first appearance; and
the first setting corresponds to the second appearance.

4. The method of claim 1, wherein the first computer system is in communication with one or more output devices, the method further comprising:
before detecting the input corresponding to the user interface element to apply the respective set of one or more settings to the first computer system, detecting a first event;
in response to detecting the first event, outputting, via the one or more output devices, a non-visual output;
after detecting the input corresponding to the user interface element to apply the respective set of one or more settings to the first computer system, detecting a second event separate from the first event, wherein the second event is the same type of event as the first event; and
in response to detecting the second event, forgoing output of, via the one or more output devices, the non-visual output.

5. The method of claim 1, wherein the second computer system is configured to operate according to the respective set of one or more settings while the respective set of one or more settings is received by the first computer system.

6. The method of claim 1, wherein:
the user interface includes a first user interface element corresponding to a first application;
the user interface includes a second user interface element corresponding to a second application;
the second user interface element is different from the first user interface element;
the second application is different from the first application;
the first user interface element has a first appearance before detecting the input corresponding to the user interface element to apply the respective set of one or more settings to the first computer system;
the first user interface element has a second appearance in response to detecting the input corresponding to the user interface element to apply the respective set of one or more settings to the first computer system;
the second appearance is different from the first appearance;
the second user interface element has a third appearance before detecting the input corresponding to the user interface element to apply the respective set of one or more settings to the first computer system;
the second user interface element has a fourth appearance in response to detecting the input corresponding to the user interface element to apply the respective set of one or more settings to the first computer system;
the third appearance is different from the second appearance and the first appearance; and
the fourth appearance is different from the third appearance, the second appearance, and the first appearance.

7. The method of claim 1, further comprising:
before displaying the user interface according to the first set of one or more settings, displaying another user interface according to the first set of one or more settings, wherein the other user interface is separate from the user interface.

8. The method of claim 7, wherein the user interface is from a first application, wherein the other user interface is from a second application, and wherein the second application is different from the first application.

9. The method of claim 1, further comprising:
while the first computer system is configured according to the first set of one or more settings, detecting, via the one or more input devices, an input corresponding to a request to share the first set of one or more settings; and
in response to detecting the input corresponding to the request to share the first set of one or more settings:
in accordance with a determination to share the first set of one or more settings with a computer system of a first type, sending a first subset of settings of the first set of one or more settings; and
in accordance with a determination to share the first set of one or more settings with a computer system of a second type, sending a second subset of settings of the first set of one or more settings, wherein the second subset is different from the first subset.

10. The method of claim 1, wherein the respective set of one or more settings includes a setting configured to be applied to a computer system of a first type, wherein the respective set of one or more settings includes a setting configured to be applied to a computer system of a second type, wherein the setting configured to be applied to a computer system of the second type is different from the setting configured to be applied to a computer system of the first type, and wherein a computer system of the second type is different from a computer system of the first type.

11. The method of claim 1, further comprising:
in response to detecting the input corresponding to the user interface element to apply the respective set of one or more settings to the first computer system, displaying, via the one or more display generation components, an indication that the respective set of one or more settings are currently being used by the first computer system.

12. The method of claim 11, further comprising:
detecting, via the one or more input devices, a set of one or more inputs, wherein the set of one or more input includes an input corresponding to the indication that the respective set of one or more settings are currently being used by the first computer system; and
in response to detecting the set of one or more inputs, displaying, via the one or more display generation components, the user interface according to the first set of one or more settings.

13. The method of claim 11, further comprising:
while displaying the indication that the respective set of one or more settings are currently being used by the first computer system, detecting, via the one or more input devices, an input corresponding to the indication that the respective set of one or more settings are currently being used by the first computer system;
in response to detecting the input corresponding to the indication that the respective set of one or more settings are currently being used by the first computer system, displaying, via the one or more display generation components, a user interface element to return to the first set of one or more settings;
while displaying the user interface element to return to the first set of one or more settings, detecting, via the one or more input devices, an input corresponding to the user interface element to return to the first set of one or more settings; and
in response to detecting the input corresponding to the user interface element to return to the first set of one or more settings, displaying, via the one or more display generation components, the user interface according to the first set of one or more settings.

14. The method of claim 11, further comprising:
while displaying the indication that the respective set of one or more settings are currently being used by the first computer system, detecting, via the one or more input devices, an input corresponding to a request to display another user interface, wherein the other user interface is different from the user interface; and
in response to detecting the input corresponding to the request to display the other user interface:
displaying, via the one or more display generation components, the other user interface; and
maintaining display of, via the one or more display generation components, the indication that the respective set of one or more settings are currently being used by the first computer system.

15. The method of claim 1, wherein the user interface is a first user interface, the method further comprising:
after displaying, via the one or more display generation components, a second user interface according to the respective set of one or more settings:
in accordance with a determination that the computer system has been locked since displaying the second user interface according to the respective set of one or more settings, displaying, via the one or more display generation components, a third user interface according to the first set of one or more settings; and
in accordance with a determination that the computer system has not been locked since displaying the second user interface according to the respective set of one or more settings, displaying, via the one or more display generation components, the third user interface according to the respective set of one or more settings.

16. The method of claim 1, wherein the user interface is a first user interface, the method further comprising:
while displaying, via the one or more display generation components, a second user interface according to the respective set of one or more settings, detecting that the second computer system is no longer in proximity with the computer system; and
in response to detecting that the second computer system is no longer in proximity with the first computer system, displaying, via the one or more display generation components, the second user interface according to the first set of one or more settings.

17. The method of claim 1, wherein the respective set of one or more settings includes at least one setting that is the same as a setting included in the first set of one or more settings.

18. The method of claim 1, wherein the user interface is displayed with a third appearance when displayed according to the first set of one or more settings, the method further comprising:
while displaying the user interface according to the first set of one or more settings, receiving, from a third computer system different from the first computer system and the second computer system, a second set of one or more settings;
in response to receiving the second set of one or more settings, displaying, via the one or more display generation components, a user interface element to apply the second set of one or more settings to the first computer system;
while displaying the user interface element to apply the second set of one or more settings to the first computer system, detecting, via the one or more input devices, an input corresponding to the user interface element to apply the second set of one or more settings to the first computer system; and
in response to detecting the input corresponding to the user interface element to apply the second set of one or more settings to the first computer system, displaying, via the one or more display generation components, the user interface with a fourth appearance different from the first appearance, the second appearance, and the third appearance.

19. A non-transitory computer-readable storage medium storing one or more programs configured to be executed by one or more processors of a first computer system that is in communication with one or more display generation components and one or more input devices, the one or more programs including instructions for:
displaying, via the one or more display generation components, a user interface according to a first set of one or more settings;
while displaying the user interface according to the first set of one or more settings, receiving, from a second computer system different from the first computer system, a respective set of one or more settings;
in response to receiving the respective set of one or more settings, displaying, via the one or more display generation components, a user interface element to apply the respective set of one or more settings to the first computer system;
while displaying the user interface element to apply the respective set of one or more settings to the first computer system, detecting, via the one or more input devices, an input corresponding to the user interface element to apply the respective set of one or more settings to the first computer system; and
in response to detecting the input corresponding to the user interface element to apply the respective set of one or more settings to the first computer system:
in accordance with a determination that the respective set of one or more settings includes a first setting, displaying, via the one or more display generation components, the user interface with a first appearance according to the first setting; and
in accordance with a determination that the respective set of one or more settings includes a second setting, displaying, via the one or more display generation components, the user interface with a second appearance according to the second setting, wherein the second setting is different from the first setting, and wherein the second appearance is different from the first appearance.

20. A first computer system configured to communicate with one or more display generation components and one or more input devices, the first computer system comprising:
one or more processors; and
memory storing one or more programs configured to be executed by the one or more processors, the one or more programs including instructions for:
displaying, via the one or more display generation components, a user interface according to a first set of one or more settings;
while displaying the user interface according to the first set of one or more settings, receiving, from a second computer system different from the first computer system, a respective set of one or more settings;
in response to receiving the respective set of one or more settings, displaying, via the one or more display generation components, a user interface element to apply the respective set of one or more settings to the first computer system;
while displaying the user interface element to apply the respective set of one or more settings to the first computer system, detecting, via the one or more input devices, an input corresponding to the user interface element to apply the respective set of one or more settings to the first computer system; and
in response to detecting the input corresponding to the user interface element to apply the respective set of one or more settings to the first computer system:
in accordance with a determination that the respective set of one or more settings includes a first setting, displaying, via the one or more display generation components, the user interface with a first appearance according to the first setting; and
in accordance with a determination that the respective set of one or more settings includes a second setting, displaying, via the one or more display generation components, the user interface with a second appearance according to the second setting, wherein the second setting is different from the first setting, and wherein the second appearance is different from the first appearance.
